(19) United States
(12) Patent Application Publication
(10) Pub. No.: US 2025/0095921 A1
(43) Pub. Date: Mar. 20, 2025

(54) ELECTRONIC COMPONENT

(71) Applicant: TDK Corporation, Tokyo (JP)

(72) Inventors: Ken MORITA, Tokyo (JP); Yasuhiro OKUI, Tokyo (JP); Yuichi NAGAI, Tokyo (JP); Kazuyuki HASEBE, Tokyo (JP); Shinya ONODERA, Tokyo (JP)

(73) Assignee: TDK Corporation, Tokyo (JP)

(21) Appl. No.: 18/775,472

(22) Filed: Jul. 17, 2024

(30) Foreign Application Priority Data
Sep. 20, 2023 (JP) 2023-152026

(51) Int. Cl. H01G 4/248; H01G 4/012; H01G 4/30

(52) U.S. Cl. CPC H01G 4/248; H01G 4/012; H01G 4/30

(57) ABSTRACT

An element body includes a main surface and a pair of end surfaces. Each external electrode includes a conductive resin layer on the main surface. Each auxiliary internal electrode is disposed in the same layer as a corresponding internal electrode of a plurality of internal electrodes and is electrically connected to the external electrode to which the corresponding internal electrode is not electrically connected. Each auxiliary internal electrode includes first and second electrode portions. The first electrode portion is exposed to a corresponding end surface of the pair of end surfaces and is electrically and physically connected to the external electrode to which the corresponding internal electrode is not electrically connected. The second electrode portion is positioned between the conductive resin layer of the external electrode to which the corresponding internal electrode is not electrically connected and the corresponding internal electrode.

### CROSS-REFERENCE TO RELATED APPLICATIONS

This application is based upon and claims the benefit of priority from Japanese Patent Application No. 2023-152026, filed on Sep. 20, 2023, the entire contents of which are incorporated herein by reference.

### BACKGROUND

### Field

The present disclosure relates to an electronic component.

### Description of the Related Art

Known electronic components include an element body of a rectangular parallelepiped shape, a plurality of external electrodes, and a plurality of internal electrodes (see, for example, Japanese Unexamined Patent Publication No. 2018-6501). The element body includes a first main surface arranged to constitute a mounting surface, a second main surface opposing the first main surface in a first direction, a pair of end surfaces opposing each other in a second direction, and a pair of side surfaces opposing each other in a third direction. The plurality of external electrodes are disposed on both ends of the element body in the second direction. The plurality of internal electrodes are disposed in the element body to be distributed in the third direction and are each electrically connected to a corresponding external electrode of the plurality of external electrodes. The external electrode includes a conductive resin layer.

### SUMMARY

The conductive resin layer includes, for example, a plurality of metal particles and a resin. In a configuration in which the external electrode includes the conductive resin layer, migration may occur in the external electrode. The migration is considered to occur due to the following events, for example.

Electric field or heat acts on the conductive resin layer, and the metal particle is ionized. Generated metal ion is attracted by electric field between the external electrodes and migrates from the conductive resin layer. The electric field acting on the metal particle includes, for example, electric field between the external electrode and the internal electrode in the element body. The metal ion migrating from the conductive resin layer react with, for example, an electron supplied from the internal electrode or the external electrode, and is deposited as metal on a surface of the element body.

One aspect of the present disclosure provides an electronic component reducing occurrence of migration even in a configuration in which an external electrode includes a conductive resin layer.

An electronic component according to one aspect of the present disclosure includes an element body of a rectangular parallelepiped shape, a plurality of external electrodes, a plurality of internal electrodes, and a plurality of auxiliary internal electrodes. The element body includes a first main surface arranged to constitute a mounting surface, a second main surface opposing the first main surface in a first direction, a pair of end surfaces opposing each other in a second direction, and a pair of side surfaces opposing each other in a third direction. The plurality of external electrodes are disposed on both ends of the element body in the second direction. The plurality of internal electrodes are disposed in the element body to be distributed in the third direction and are each electrically connected to a corresponding external electrode of the plurality of external electrodes. The plurality of auxiliary internal electrodes are each disposed in the same layer as a corresponding internal electrode of the plurality of internal electrodes and are each electrically connected to the external electrode to which the corresponding internal electrode is not electrically connected. Each of the plurality of external electrodes includes a conductive resin layer positioned on the first main surface. Each of the plurality of auxiliary internal electrodes includes a first electrode portion and a second electrode portion. The first electrode portion is exposed to a corresponding end surface of the pair of end surfaces and is electrically and physically connected to the external electrode to which the corresponding internal electrode is not electrically connected. The second electrode portion is positioned between the conductive resin layer included in the external electrode to which the corresponding internal electrode is not electrically connected and the corresponding internal electrode.

In the one aspect described above, the auxiliary internal electrode is electrically connected to the external electrode to which the corresponding internal electrode is not electrically connected. The second electrode portion of the auxiliary internal electrode is positioned between the conductive resin layer on the first main surface included in the external electrode to which the auxiliary internal electrode is electrically connected and the internal electrode in the same layer as the auxiliary internal electrode. The second electrode portion of the auxiliary internal electrode is positioned between the conductive resin layer on the first main surface and the internal electrode that are not electrically connected to each other. Therefore, electric field tends not to be generated between the conductive resin layer on the first main surface and the internal electrode that are not electrically connected to each other. Consequently, the one aspect described above reduces occurrence of migration.

In the one aspect described above, the first electrode portion may be exposed to the corresponding end surface with a width larger than a width of the second electrode portion.

A configuration in which the first electrode portion is exposed to the corresponding end surface with the width larger than a width of the second electrode portion increases a physical connection length between the first electrode portion and the external electrode, as compared with, for example, a configuration in which the first electrode portion is exposed to the corresponding end surface with the same width as the width of the second electrode portion. Therefore, the configuration in which the first electrode portion is exposed to the corresponding end surface with the width larger than the width of the second electrode portion improves connectivity between the external electrode and the auxiliary internal electrode.

In the one aspect described above, each of the plurality of internal electrodes may include: a third electrode portion including a first end exposed to a corresponding end surface of the pair of end surfaces, the third electrode portion having a first width and being separated from the first main surface by a first distance; and a fourth electrode portion including a second end positioned in the element body and opposing the first end in the second direction, the fourth electrode portion having a second width smaller than the first width and being separated from the first main surface by a second distance larger than the first distance. The second electrode portion may be positioned between the conductive resin layer included in the external electrode to which the corresponding internal electrode is not electrically connected and the fourth electrode portion.

A configuration in which the auxiliary internal electrode is disposed in the same layer as the internal electrode tends to decrease an area of the internal electrode. A decrease in the area of the internal electrode may lead to a decrease in capacitance.

A configuration in which the internal electrode includes the third electrode portion and the fourth electrode portion, and the second electrode portion is positioned between the conductive resin layer and the fourth electrode portion that are not electrically connected to each other prevents a decrease in an area of the internal electrode.

In the one aspect described above, each of the plurality of external electrodes may include a conductive resin layer positioned on the second main surface, the third electrode portion may be separated from the second main surface by a third distance, and the fourth electrode portion may be separated from the second main surface by a fourth distance larger than the third distance. Each of the plurality of auxiliary internal electrodes may include an electrode portion positioned between the conductive resin layer on the second main surface included in the external electrode to which the corresponding internal electrode is not electrically connected and the fourth electrode portion.

The above-described electrode portion of the auxiliary internal electrode is positioned between the conductive resin layer on the second main surface and the internal electrode that are not electrically connected to each other. Therefore, electric field tends not to be generated between the conductive resin layer on the second main surface and the internal electrode that are not electrically connected to each other. Consequently, even in a configuration in which the external electrode includes the conductive resin layer on the second main surface, a configuration in which the auxiliary internal electrode includes the above-described electrode portion reduces occurrence of migration.

A configuration in which the internal electrode includes the third electrode portion and the fourth electrode portion, and the above-described electrode portion of the auxiliary internal electrode is positioned between the conductive resin layer on the second main surface and the fourth electrode portion that are not electrically connected to each other prevents a decrease in an area of the internal electrode.

In the one aspect described above, the conductive resin layer may include an end edge positioned on the first main surface, and the second electrode portion may include an end opposing an end included in the first electrode portion and exposed to the corresponding end surface in the second direction. With a plane including the corresponding end surface as a reference plane, the auxiliary internal electrode and the conductive resin layer that are electrically connected to each other may have a relationship in which a length from the reference plane to the end included in the second electrode portion is larger than a length from the reference plane to the end edge included in the conductive resin layer.

In a configuration in which the auxiliary internal electrode and the conductive resin layer that are electrically connected to each other have the above-described relationship, the electric field tends not to be reliably generated between the conductive resin layer on the first main surface and the internal electrode that are not electrically connected to each other. Therefore, this configuration reliably reduces the occurrence of the migration.

In the one aspect described above, when the auxiliary internal electrode and the conductive resin layer that are electrically connected to each other are viewed from a direction orthogonal to the first main surface, the second electrode portion may include a portion exposed from the conductive resin layer.

In a configuration in which the second electrode portion includes the portion exposed from the conductive resin layer when the auxiliary internal electrode and the conductive resin layer that are electrically connected to each other are viewed from the direction orthogonal to the first main surface, the electric field tends not to be reliably generated between the conductive resin layer on the first main surface and the internal electrode that are not electrically connected to each other. Therefore, this configuration reliably reduces the occurrence of the migration.

In the one aspect described above, with a plane including the corresponding end surface to which the auxiliary internal electrode is exposed as a reference plane, the internal electrode and the auxiliary internal electrode that are disposed in the same layer may have a relationship in which a length of the auxiliary internal electrode from the reference plane is larger than a length from the reference plane to the internal electrode.

In a configuration in which the internal electrode and the auxiliary internal electrode that are disposed in the same layer have the above-described relationship, the electric field tends not to be reliably generated between the conductive resin layer on the first main surface and the internal electrode that are not electrically connected to each other. Therefore, this configuration reliably reduces the occurrence of the migration.

In this configuration, the internal electrode and the auxiliary internal electrode that are disposed in the same layer may have a relationship in which the length from the reference plane to the internal electrode is smaller than the length of the auxiliary internal electrode from the reference plane. This configuration can increase a length of the internal electrode in the second direction. Therefore, this configuration can increase capacitance.

In the one aspect described above, the conductive resin layer may include an end edge positioned on the first main surface. With a plane including the end surface to which the internal electrode is exposed as a reference plane, the internal electrode and the conductive resin layer that are not electrically connected to each other may have a relationship in which a length of the internal electrode from the reference plane is larger than a length from the reference plane to the end edge included in the conductive resin layer.

A configuration in which the internal electrode and the conductive resin layer that are not electrically connected to each other have the above-described relationship can increase a length of the internal electrode in the second direction. Therefore, this configuration can increase capacitance.

In the one aspect described above, each of the plurality of external electrodes may include a conductive resin layer positioned on the side surface. The plurality of internal electrodes may include an outermost internal electrode adjacent to the conductive resin layer on the side surface in the third direction and electrically connected to the conductive resin layer on the side surface. The conductive resin layer on the side surface not electrically connected to the outermost internal electrode and the outermost internal electrode may not overlap each other when viewed from a direction orthogonal to the side surface.

In a configuration in which the outermost internal electrode is adjacent to the conductive resin layer on the side surface in the third direction and is electrically connected to the conductive resin layer on the side surface, the outermost internal electrode is positioned between the conductive resin layer on the side surface and the internal electrode adjacent to and not electrically connected to the outermost internal electrode. The outermost internal electrode is positioned between the conductive resin layer on the side surface and the internal electrode that are not electrically connected to each other. Therefore, electric field tends not to be generated between the conductive resin layer on the side surface and the internal electrode that are not electrically connected to each other.

In a configuration in which the conductive resin layer on the side surface not electrically connected to the outermost internal electrode and the outermost internal electrode do not overlap each other when viewed from a direction orthogonal to the side surface, electric field tends not to be generated between the conductive resin layer on the side surface and the outermost internal electrode that are not electrically connected to each other.

Consequently, these configurations reduce occurrence of migration even in a configuration in which the external electrode includes the conductive resin layer on the side surface.

In the one aspect described above, each of the plurality of external electrodes further may include a conductive resin layer positioned on the side surface, and the conductive resin layer on the side surface and the internal electrode that are not electrically connected to each other may not overlap each other when viewed from a direction orthogonal to the side surface.

In a configuration in which the conductive resin layer on the side surface and the internal electrode that are not electrically connected to each other do not overlap each other when viewed from the direction orthogonal to the side surface, electric field tends not to be generated between the conductive resin layer on the side surface and the internal electrode that are not electrically connected to each other. Therefore, this configuration reduces occurrence of migration even in a configuration in which the external electrode includes the conductive resin layer on the side surface.

In the one aspect described above, each of the plurality of external electrodes may include a conductive resin layer positioned on the end surface. When the conductive resin layer positioned on the end surface and the end surface are viewed from a direction orthogonal to the end surface, the end surface may include: a first region covered with the conductive resin layer on the end surface; and a second region exposed from the conductive resin layer on the end surface and closer to the second main surface than the first region.

A configuration in which the end surface includes the first region and the second region when the conductive resin layer positioned on the end surface and the end surface are viewed from the direction orthogonal to the end surface reduces ESR (equivalent series resistance), as compared with a configuration in which the conductive resin layer covers the entire end surface.

In the one aspect described above, the conductive resin layer may include a plurality of silver particles.

### BRIEF DESCRIPTION OF THE DRAWINGS

FIG. 1 is a perspective view of a multilayer capacitor according to a first example;

FIG. 2 is a view illustrating a cross-sectional configuration of the multilayer capacitor according to the first example;

FIG. 3 is a view illustrating a cross-sectional configuration of the multilayer capacitor according to the first example;

FIG. 4 is a view illustrating a cross-sectional configuration of the multilayer capacitor according to the first example;

FIG. 5 is a view illustrating a cross-sectional configuration of the multilayer capacitor according to the first example;

FIG. 6 is a view illustrating a relationship among an internal electrode, an auxiliary internal electrode, and a second electrode layer;

FIG. 7 is a view illustrating a cross-sectional configuration of a multilayer capacitor according to a modified example of the first example;

FIG. 8 is a view illustrating a cross-sectional configuration of the multilayer capacitor according to the modified example of the first example;

FIG. 9 is a perspective view of a multilayer capacitor according to a second example;

FIG. 10 is a view illustrating a cross-sectional configuration of the multilayer capacitor according to the second example;

FIG. 11 is a view illustrating a cross-sectional configuration of the multilayer capacitor according to the second example;

FIG. 12 is a view illustrating a cross-sectional configuration of the multilayer capacitor according to the second example;

FIG. 13 is a view illustrating a cross-sectional configuration of the multilayer capacitor according to the second example;

FIG. 14 is a view illustrating a relationship among an internal electrode, an auxiliary internal electrode, and a second electrode layer;

FIG. 15 is a perspective view of a multilayer capacitor according to a third example;

FIG. 16 is a view illustrating a cross-sectional configuration of the multilayer capacitor according to the third example;

FIG. 17 is a view illustrating a cross-sectional configuration of the multilayer capacitor according to the third example;

FIG. 18 is a perspective view of a multilayer capacitor according to a fourth example;

FIG. 19 is a view illustrating a cross-sectional configuration of the multilayer capacitor according to the fourth example;

FIG. 20 is a view illustrating a cross-sectional configuration of the multilayer capacitor according to the fourth example;

FIG. 21 is a view illustrating a cross-sectional configuration of the multilayer capacitor according to the fourth example;

FIG. 22 is a view illustrating a cross-sectional configuration of a multilayer capacitor according to a modified example of the fourth example;

FIG. 23 is a view illustrating a cross-sectional configuration of the multilayer capacitor according to the modified example of the fourth example;

FIG. 24 is a view illustrating a cross-sectional configuration of a multilayer capacitor according to a modified example of the fourth example;

FIG. 25 is a view illustrating a cross-sectional configuration of the multilayer capacitor according to the modified example of the fourth example;

FIG. 26 is a view illustrating a cross-sectional configuration of a multilayer capacitor according to a modified example of the fourth example;

FIG. 27 is a view illustrating a cross-sectional configuration of the multilayer capacitor according to the modified example of the fourth example; and

FIG. 28 is a view illustrating a cross-sectional configuration of an electronic component device according to a fifth example.

### DETAILED DESCRIPTION

In the following description, with reference to the drawings, the same reference numbers are assigned to the same components or to similar components having the same function, and overlapping description is omitted.

### First Example

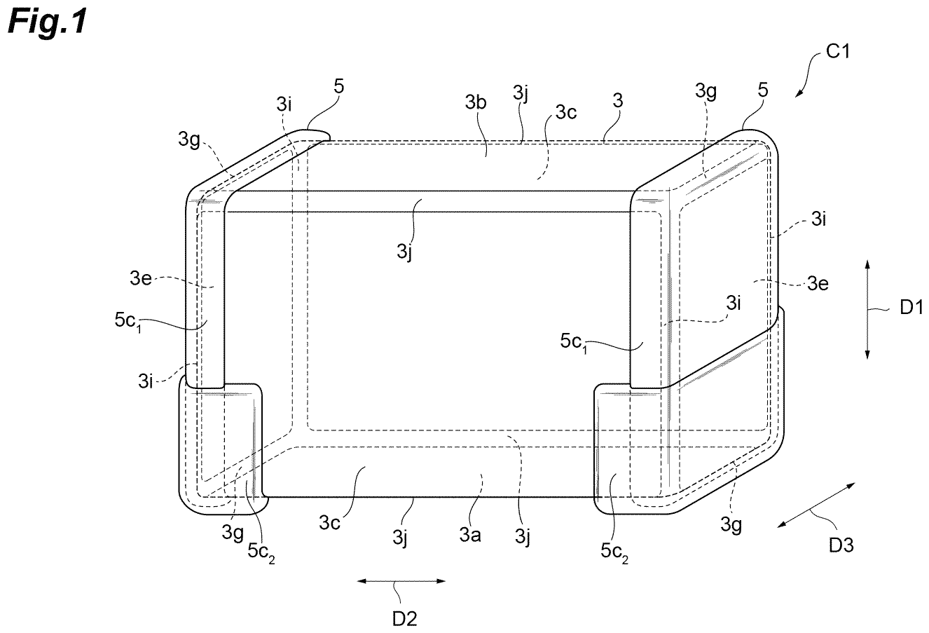

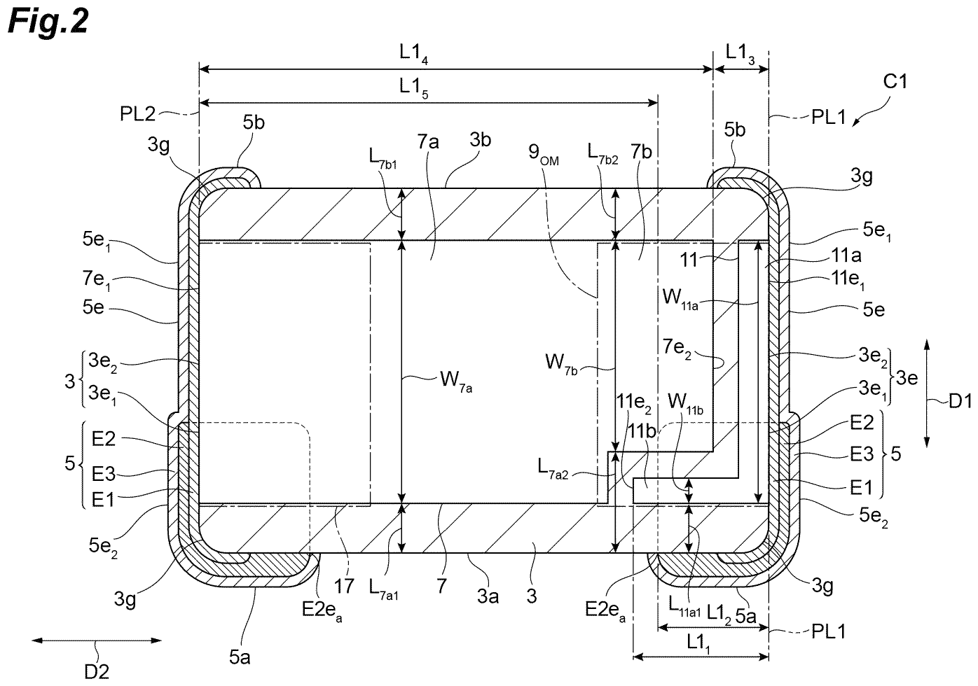

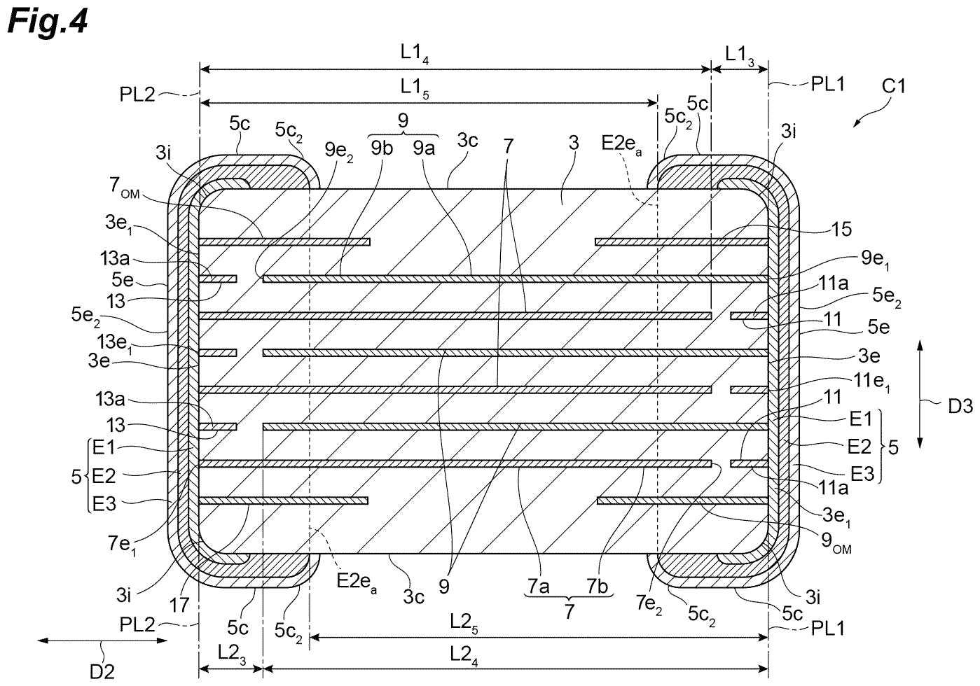

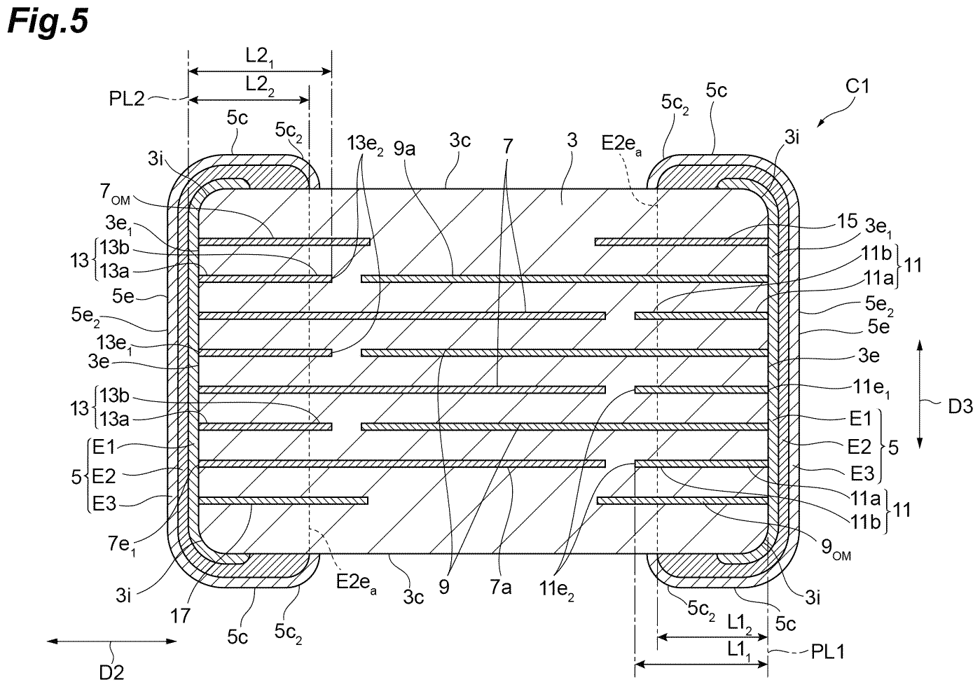

A configuration of a multilayer capacitor C1 according to the first example will be described with reference to FIGS. 1 to 5. FIG. 1 is a perspective view of a multilayer capacitor according to the first example. FIGS. 2, 3, 4, and 5 are views illustrating a cross-sectional configuration of the multilayer capacitor according to the first example.

In the first example, an electronic component includes, for example, the multilayer capacitor C1.

As illustrated in FIG. 1, the multilayer capacitor C1 includes an element body 3 of a rectangular parallelepiped shape, a plurality of external electrodes 5. For example, the multilayer capacitor C1 includes a pair of external electrodes 5. The pair of external electrodes 5 are disposed on an outer surface of the element body 3. The pair of external electrodes 5 are separated from each other. The rectangular parallelepiped shape includes a rectangular parallelepiped shape in which corners and ridges are chamfered, or a rectangular parallelepiped shape in which the corners and ridges are rounded.

The element body 3 includes a pair of main surfaces 3a and 3b opposing each other, a pair of side surfaces 3c opposing each other, and a pair of end surfaces 3e opposing each other. The pair of main surfaces 3a and 3b, the pair of side surfaces 3c, and the pair of end surfaces 3e each have a substantially rectangular shape. A direction in which the pair of main surfaces 3a and 3b oppose each other includes a first direction D1. A direction in which the pair of side surfaces 3c oppose each other includes a third direction D3. A direction in which the pair of end surfaces 3e oppose each other includes a second direction D2.

The multilayer capacitor C1 is solder-mounted on an electronic device, for example. The electronic device includes, for example, a circuit board or an electronic component. In the multilayer capacitor C1, for example, the main surfaces 3a opposes the electronic device. The main surface 3a is arranged to constitute a mounting surface. The main surface 3a includes the mounting surface. For example, when the main surface 3a includes the first main surface, the main surface 3b includes the second main surface.

The first direction D1 includes a direction orthogonal to the main surfaces 3a and 3b, and is orthogonal to the third direction D3. The second direction D2 includes a direction parallel to the main surfaces 3a and 3b and the side surfaces 3c, and is orthogonal to the first direction D1 and the third direction D3. The third direction D3 includes a direction orthogonal to the side surfaces 3c, and the second direction D2 includes a direction orthogonal to the end surfaces 3e.

The pair of side surfaces 3c extend in the first direction D1 to couple the pair of main surfaces 3a and 3b. The pair of side surfaces 3c also extend in the second direction D2. The pair of end surfaces 3e extend in the first direction D1 to couple the pair of main surfaces 3a and 3b. The pair of end surfaces 3e also extend in the third direction D3.

For example, a length of the element body 3 in the second direction D2 is larger than a length of the element body 3 in the first direction D1 and larger than a length of the element body 3 in the third direction D3. The second direction D2 includes a longitudinal direction of the element body 3. The length of the element body 3 in the first direction D1 and the length of the element body 3 in the third direction D3 may be equal to each other. The length of the element body 3 in the first direction D1 and the length of the element body 3 in the third direction D3 may be different from each other.

The length of the element body 3 in the first direction D1 defines, for example, a height of the element body 3. The length of the element body 3 in the third direction D3 defines, for example, a width of the element body 3. The length of the element body 3 in the second direction D2 defines, for example, a longitudinal length of the element body 3. For example, the height of the element body 3 is 0.1 to 3.2 mm, the width of the element body 3 is 0.1 to 6.3 mm, and the longitudinal length of the element body 3 is 0.2 to 7.5 mm. For example, the height of the element body 3 is 2.5 mm, the width of the element body 3 is 2.5 mm, and the longitudinal length of the element body 3 is 3.2 mm.

The element body 3 includes four ridge portions 3g, four ridge portions 3i, and four ridge portions 3j. The ridge portions 3g are positioned between the end surfaces 3e and the main surfaces 3a and 3b. The ridge portions 3i are positioned between the end surfaces 3e and the side surfaces 3c. The ridge portions 3j are positioned between the main surfaces 3a and 3b and the side surfaces 3c. For example, the ridge portions 3g, 3i, and 3j are rounded to be curved. For example, the element body 3 is subjected to what is called a round chamfering process. Each of the end surfaces 3e and each of the main surfaces 3a and 3b are indirectly adjacent to each other with the ridge portion 3g interposed therebetween. Each of the end surfaces 3e and each of the side surfaces 3c are indirectly adjacent to each other with the ridge portion 3i interposed therebetween. Each of the main surfaces 3a and 3b and each of the side surfaces 3c are indirectly adjacent to each other with the ridge portion 3j interposed therebetween.

The element body 3 is configured through laminating a plurality of dielectric layers in the third direction D3. The element body 3 includes a plurality of laminated dielectric layers. In the element body 3, a lamination direction of the plurality of dielectric layers coincides with the third direction D3. Each dielectric layer includes, for example, a sintered body of a ceramic green sheet containing a dielectric material. Examples of the dielectric material include dielectric ceramics. Examples of the dielectric ceramics include BaTiO₃-based, Ba (Ti, Zr) O₃-based, or (Ba, Ca)TiO₃-based dielectric ceramics. In the actual element body 3, each of the dielectric layers is integrated to such an extent that a boundary between the dielectric layers cannot be visually recognized.

As illustrated in FIG. 1, the external electrodes 5 are disposed at both ends of the element body 3 in the second direction D2. Each external electrode 5 is disposed on a corresponding end surface 3e of the pair of end surfaces 3e. For example, each external electrode 5 is disposed on the pair of main surfaces 3a and 3b, the pair of side surfaces 3c, and the end surface 3e. The external electrode 5 includes a plurality of electrode portions 5a, 5b, 5c, and 5e, as illustrated in FIGS. 2 to 4. The electrode portion 5a is disposed on the main surface 3a. The electrode portion 5a may be disposed on the ridge portion 3g. The electrode portion 5b is disposed on the main surface 3b. The electrode portion 5b may be disposed on the ridge portion 3g. The electrode portion 5c is disposed on the side surface 3c. The electrode portion 5c may be disposed on the ridge portion 3i. The electrode portion 5e is disposed on the end surface 3e. The external electrode 5 also includes an electrode portion disposed on the ridge portion 3j.

Each external electrode 5 is formed on five surfaces of the pair of main surfaces 3a and 3b, the pair of side surfaces 3c, and the end surface 3e as well as the ridge portions 3g, 3i, and 3j. The electrode portions 5a, 5b, 5c, and 5e adjacent to each other are coupled and are electrically connected to each other. As illustrated in FIGS. 2 to 4, the external electrode 5 includes a first electrode layer E1, a second electrode layer E2, and a third electrode layer E3. The third electrode layer E3 is arranged to include the outermost layer of the external electrode 5. Each of the electrode portions 5a, 5c, and 5e includes the first electrode layer E1, the second electrode layer E2, and the third electrode layer E3. The electrode portions 5b includes the first electrode layer E1 and the third electrode layer E3.

The first electrode layer E1 of the electrode portion 5a is disposed on the main surface 3a. The first electrode layer E1 of the electrode portion 5a covers a partial region of the main surface 3a. The first electrode layer E1 of the electrode portion 5a is in contact with the partial region of the main surface 3a. In the electrode portion 5a, the first electrode layer E1 is in direct contact with the element body 3. The main surface 3a is covered with the first electrode layer E1 at the partial region, and is exposed from the first electrode layer E1 at the remaining region excluding the partial region. The partial region of the main surface 3a is positioned closer to the end surface 3e. The first electrode layer E1 of the electrode portion 5a is positioned on the main surface 3a. The first electrode layer E1 may not be disposed on the main surface 3a.

The second electrode layer E2 of the electrode portion 5a is disposed on both the first electrode layer E1 and the main surface 3a. The second electrode layer E2 of the electrode portion 5a is formed on the first electrode layer E1 to cover the first electrode layer E1 of the electrode portion 5a, and is formed on the main surface 3a to cover a part of the main surface 3a. The second electrode layer E2 of the electrode portion 5a is in contact with substantially the entire first electrode layer E1 and the above-described part of the main surface 3a. In the electrode portion 5a, the second electrode layer E2 is in direct contact with the first electrode layer E1 and the main surface 3a. In the electrode portion 5a, the second electrode layer E2 indirectly covers the main surface 3a such that the first electrode layer E1 is positioned between the second electrode layer E2 and the main surface 3a. The second electrode layer E2 of the electrode portion 5a is positioned on the main surface 3a. The second electrode layer E2 of the electrode portion 5a includes an end edge E2eₐ positioned on the main surface 3a.

The third electrode layer E3 of the electrode portion 5a is disposed on the second electrode layer E2. In the electrode portion 5a, the third electrode layer E3 covers the second electrode layer E2. In the electrode portion 5a, the third electrode layer E3 is in contact with the second electrode layer E2. In the electrode portion 5a, the third electrode layer E3 is in direct contact with the second electrode layer E2. In the electrode portion 5a, the third electrode layer E3 is not in direct contact with the first electrode layer E1. The third electrode layer E3 of the electrode portion 5a is positioned on the main surface 3a.

The first electrode layer E1 of the electrode portion 5b is disposed on the main surface 3b. The first electrode layer E1 of the electrode portion 5b covers a partial region of the main surface 3b. The first electrode layer E1 of the electrode portion 5b is in contact with the partial region of the main surface 3b. In the electrode portion 5b, the first electrode layer E1 is in direct contact with the element body 3. The main surface 3b is covered with the first electrode layer E1 at the partial region, and is exposed from the first electrode layer E1 at the remaining region excluding the partial region. The partial region of the main surface 3b is positioned closer to the end surface 3e. The first electrode layer E1 of the electrode portion 5b is positioned on the main surface 3b. The first electrode layer E1 may not be disposed on the main surface 3b.

The third electrode layer E3 of the electrode portion 5b is disposed on the first electrode layer E1. In the electrode portion 5b, the third electrode layer E3 covers the first electrode layer E1. In the electrode portion 5b, the third electrode layer E3 is in contact with the first electrode layer E1. In the electrode portion 5b, the third electrode layer E3 is in direct contact with the first electrode layer E1. The third electrode layer E3 of the electrode portion 5b is positioned on the main surface 3b. The electrode portion 5b does not include the second electrode layer E2. The main surface 3b is not covered with the second electrode layer E2.

The first electrode layer E1 of the electrode portion 5c is disposed on the side surface 3c. The first electrode layer E1 of the electrode portion 5c covers a partial region of the side surface 3c. The first electrode layer E1 of the electrode portion 5c is in contact with the partial region of the side surface 3c. In the electrode portion 5c, the first electrode layer E1 is in direct contact with the element body 3. The side surface 3c is covered with the first electrode layer E1 at the partial region, and is exposed from the first electrode layer E1 at the remaining region excluding the partial region. The partial region of the side surface 3c is positioned closer to the end surface 3e. The first electrode layer E1 of the electrode portion 5c is positioned on the side surface 3c. The first electrode layer E1 may not be disposed on the side surface 3c.

The second electrode layer E2 of the electrode portion 5c is disposed on both the first electrode layer E1 and the side surface 3c. In the electrode portion 5c, the second electrode layer E2 covers a part of the first electrode layer E1 and a part of the side surface 3c. In the electrode portion 5c, the second electrode layer E2 is in direct contact with the above-described part of the first electrode layer E1 and the above-described part of the side surface 3c. The second electrode layer E2 of the electrode portion 5c covers the above-described part of the first electrode layer E1 of the electrode portion 5c. A region included in the side surface 3c and covered with the second electrode layer E2 is positioned closer to the main surface 3a and the end surface 3e, for example. In the electrode portion 5c, the second electrode layer E2 indirectly covers the side surface 3c such that the first electrode layer E1 is positioned between the second electrode layer E2 and the side surface 3c. The first electrode layer E1 of the electrode portion 5c is covered with the second electrode layer E2 at the above-described part, and is exposed from the second electrode layer E2 at the remaining part excluding the above-described part. The second electrode layer E2 of the electrode portion 5c is positioned on the side surface 3c.

The third electrode layer E3 of the electrode portion 5c is disposed on both the second electrode layer E1 and the second electrode layer E2. In the electrode portion 5c, the third electrode layer E3 covers the entire second electrode layer E2 and covers an entire portion, of the first electrode layer E1, exposed from the second electrode layer E2. In the electrode portion 5c, the third electrode layer E3 is in contact with substantially the entire second electrode layer E2 and is in contact with substantially the entire portion, of the first electrode layer E1, exposed from the second electrode layer E2. In the electrode portion 5c, the third electrode layer E3 is in direct contact with the first electrode layer E1 and the second electrode layer E2. The third electrode layer E3 of the electrode portion 5a is positioned on the side surface 3c.

The electrode portion 5c includes a plurality of regions 5c₁ and 5c₂. For example, the electrode portion 5c includes only two regions 5c₁ and 5c₂. The region 5c₂ is positioned closer to the main surface 3a than the region 5c₁. The region 5c₁ includes the first electrode layer E1 and the third electrode layer E3. The region 5c₁ does not include the second electrode layer E2. The region 502 includes the first electrode layer E1, the second electrode layer E2, and the third electrode layer E3. The region 5c₁ includes a region where the first electrode layer E1 is exposed from the second electrode layer E2. The region 5c₂ includes a region where the first electrode layer E1 is covered with the second electrode layer E2.

The first electrode layer E1 of the electrode portion 5e is disposed on the end surface 3e. The first electrode layer E1 of the electrode portion 5e covers the entire end surface 3e. The first electrode layer E1 of the electrode portion 5e is in contact with substantially the entire end surface 3e. In the electrode portion 5e, the first electrode layer E1 is in direct contact with the end surface 3e.

The second electrode layer E2 of the electrode portion 5e is disposed on the first electrode layer E1. In the electrode portion 5e, the second electrode layer E2 covers a part of the first electrode layer E1. In the electrode portion 5e, the second electrode layer E2 is in direct contact with the above-described part of the first electrode layer E1. The second electrode layer E2 of the electrode portion 5e is formed to cover the above-described part of the first electrode layer E1 of the electrode portion 5e. In the electrode portion 5e, the second electrode layer E2 indirectly covers a part of the end surface 3e such that the first electrode layer E1 is positioned between the second electrode layer E2 and the end surface 3e. The above-described part of the end surface 3e is positioned closer to the main surface 3a, for example. The first electrode layer E1 of the electrode portion 5e is covered with the second electrode layer E2 at the above-described part, and is exposed from the second electrode layer E2 at the remaining part excluding the above-described part. The second electrode layer E2 of the electrode portion 5e is positioned on the end surface 3e.

The third electrode layer E3 of the electrode portion 5e is disposed on both the first electrode layer E1 and the second electrode layer E2. In the electrode portion 5e, the third electrode layer E3 covers the entire second electrode layer E2 and covers an entire portion, of the first electrode layer E1, exposed from the second electrode layer E2. In the electrode portion 5e, the third electrode layer E3 is in direct contact with substantially the entire second electrode layer E2 and is in direct contact with substantially the entire portion, of the first electrode layer E1, exposed from the second electrode layer E2. In the electrode portion 5e, the third electrode layer E3 is in direct contact with the first electrode layer E1 and the second electrode layer E2. The third electrode layer E3 of the electrode portion 5e is positioned on the end surface 3e.

The electrode portion 5e may not include the second electrode layer E2. In a configuration in which the electrode portion 5e does not include the second electrode layer E2, the third electrode layer E3 included in the electrode portion 5e covers the entire first electrode layer E1 and is in direct contact with the first electrode layer E1.

The electrode portion 5e includes a plurality of regions 5e₁ and 5e₂. For example, the electrode portion 5e includes only two regions 5e₁ and 5e₂. The region 5e₂ is positioned closer to the main surface 3a than the region 5e₁. The region 5e₁ includes the first electrode layer E1 and the third electrode layer E3. The region 5e₁ does not include the second electrode layer E2. The region 5e₂ includes the first electrode layer E1, the second electrode layer E2, and the third electrode layer E3. In the electrode portion 5e, the third electrode layer E3 covers the entire end surface 3e when viewed from the second direction D2. For example, the third electrode layer E3 indirectly covers the entire end surface 3e. The region 5e₁ includes a region where the first electrode layer E1 is exposed from the second electrode layer E2. The region 5e₂ includes a region where the first electrode layer E1 is covered with the second electrode layer E2.

When the end surface 3e and the second electrode layer E2 positioned on the end surface 3e are viewed from the second direction D2, the end surface 3e includes a region 3e₁ covered with the second electrode layer E2 positioned on the end surface 3e, and a region 3e₂ exposed from the second electrode layer E2 positioned on the end surface 3e. The region 3e₂ is closer to the main surface 3b than the region 3e₁. For example, when the region 3e₁ includes a first region, the region 3e₂ includes a second region.

The first electrode layer E1 is formed from sintering electrically conductive paste applied onto the surface of the element body 3. The first electrode layer E1 is formed to cover the above-described part of each of the main surfaces 3a and 3b, the above-described part of each of the side surfaces 3c, the end surface 3e, and the ridge portions 3g, 3i, and 3j. The first electrode layer E1 is formed from sintering a metal component included in the electrically conductive paste. The metal component included in the electrically conductive paste includes, for example, metal particles. The first electrode layer E1 includes a sintered metal layer. The first electrode layer E1 includes the sintered metal layer formed on the element body 3. For example, the first electrode layer E1 includes a sintered metal layer made of Cu. The first electrode layer E1 may include a sintered metal layer made of Ni. The first electrode layer E1 includes a base metal. The electrically conductive paste includes, for example, particles made of Cu or Ni, a glass component, an organic binder, and an organic solvent. The first electrode layers E1 included in the electrode portions 5a, 5b, 5c, and 5e are integrally formed.

The second electrode layer E2 is formed from curing electrically conductive resin paste applied onto the first electrode layer E1. The second electrode layer E2 is formed on both the first electrode layer E1 and the element body 3. The first electrode layer E1 includes an underlying metal layer for forming the second electrode layer E2. The second electrode layer E2 includes an electrically conductive resin layer that covers the first electrode layer E1. The conductive resin paste includes, for example, a resin, an electrically conductive material, and an organic solvent. The resin includes, for example, a thermosetting resin. The conductive material includes, for example, metal particles. The metal particles include, for example, silver particles. For example, the second electrode layer E2 includes a plurality of silver particles. The thermosetting resin includes, for example, a phenol resin, an acrylic resin, a silicone resin, an epoxy resin, or a polyimide resin. The second electrode layer E2 is in contact with a part of the ridge portion 3j. The second electrode layers E2 included in the electrode portions 5a, 5c, and 5e are integrally formed.

The third electrode layer E3 is formed on the second electrode layer E2 through a plating method. The third electrode layer E3 may have a multilayer structure. In this case, the third electrode layer E3 includes, for example, an Ni plating layer and a solder plating layer. The Ni plating layer is formed on both the second electrode layer E2 and the first electrode layer E1. The solder plating layer is formed on the Ni plating layer. The solder plating layer covers the Ni plating layer. The Ni plating layer has better solder leach resistance than the metal included in the second electrode layer E2. The third electrode layer E3 may include an Sn plating layer, a Cu plating layer, or an Au plating layer instead of the Ni plating layer. The solder plating layer includes, for example, an Sn plating layer, an Sn—Ag alloy plating layer, an Sn—Bi alloy plating layer, or an Sn—Cu alloy plating layer. The third electrode layers E3 included in the electrode portions 5a, 5c, and 5e are integrally formed.

In the multilayer capacitor C1, the second electrode layer E2 continuously covers only a part of the main surface 3a, only a part of the end surface 3e, and only a part of each of the pair of side surfaces 3c. The second electrode layer E2 includes a portion continuously covering only a part of the main surface 3a, only a part of the end surface 3e, and only a part of each of the pair of side surfaces 3c. The above-described part, of the end surface 3e, covered with the second electrode layer E2 is positioned closer to the main surface 3a. The above-described part, of the side surface 3c, covered with the second electrode layer E2 is positioned closer to the main surface 3a. The second electrode layer E2 covers the entire one ridge portion 3g, only a part of the ridge portion 3i, and only a part of the ridge portion 3j. A part of a portion, of the first electrode layer E1, covering the ridge portion 3i is exposed from the second electrode layer E2. For example, the first electrode layer E1 included in the regions 5c₁ and 5e₁ is exposed from the second electrode layer E2.

In a configuration in which the electrode portion 5e does not include the second electrode layer E2, the second electrode layer E2 continuously covers only a portion of the main surface 3a and only a portion of each of the pair of side surfaces 3c. The second electrode layer E2 includes a portion continuously covering only a part of the main surface 3a and only a part of each of the pair of side surface 3c.

As illustrated in FIGS. 2 to 5, the multilayer capacitor C1 includes a plurality of internal electrodes 7 and a plurality of internal electrodes 9. Each of the internal electrodes 7 and 9 is included in an internal conductor disposed in the element body 3. Each of the internal electrodes 7 and 9 is made of an electrically conductive material that is commonly used as an internal conductor of a multilayer electronic component. The electrically conductive material includes, for example, a base metal. The electrically conductive material includes, for example, Ni or Cu. Each of the internal electrodes 7 and 9 is configured as a sintered body of electrically conductive paste containing the electrically conductive material described above. For example, the internal electrodes 7 and 9 are made of Ni.

The internal electrodes 7 and the internal electrodes 9 are disposed in different positions (layers) in the third direction D3. The internal electrodes 7 and the internal electrodes 9 are alternately disposed in the element body 3 to oppose each other in the third direction D3 with an interval therebetween. The plurality of internal electrodes 7 and the plurality of internal electrodes 9 are alternately disposed in the third direction D3. The internal electrodes 7 and the internal electrodes 9 have different polarities from each other. An end of each of the internal electrodes 7 and 9 is exposed to a corresponding end surface 3e of the pair of end surfaces 3e. The internal electrode 7 includes the end 7e₁ exposed to the corresponding end surface 3e. The internal electrode 9 includes the end 9e₁ exposed to the corresponding end surface 3e. Each of the internal electrodes 7 and 9 is exposed only to the corresponding end surface 3e. Each of the end 7e₁ and the end 9e₁ is covered with the electrode portion 5e included in a corresponding external electrode 5 of the pair of external electrodes 5. Each of the end 7e₁ and the end 9e₁ is directly connected to the electrode portion 5e included in the corresponding external electrode 5. Each of the internal electrodes 7 and 9 is electrically connected to the corresponding external electrode 5.

The internal electrode 7 includes an end 7e₂ opposing the end 7e₁ in the second direction D2. The end 7e₂ is positioned in the element body 3. The end 7e₂ is closer to the end surface 3e to which the internal electrode 9 is exposed than the end 7e₁. The internal electrode 7 includes the pair of ends 7e₁ and 7e₂ opposing each other in the second direction D2. For example, when the end 7e₁ includes a first end, the end 7e₂ includes a second end.

The internal electrode 9 includes an end 9e₂ opposing the end 9e₁ in the second direction D2. The end 9e₂ is positioned in the element body 3. The end 9e₂ is closer to the end surface 3e to which the internal electrode 7 is exposed than the end 9e₁. The internal electrode 9 includes the pair of ends 9e₁ and 9e₂ opposing each other in the second direction D2. For example, when the end 9e₁ includes a first end, the end 9e₂ includes a second end.

The plurality of internal electrodes 7 and the plurality of internal electrodes 9 are disposed in the element body 3 to be distributed in the third direction D3. Each of the internal electrodes 7 and 9 is positioned in a plane substantially parallel to the side surfaces 3c. Each of the internal electrodes 7 and 9 is disposed to extend in a direction intersecting the main surface 3a. For example, each of the internal electrodes 7 and 9 is disposed to extend in a direction substantially orthogonal to the main surface 3a. The internal electrode 7 and the internal electrode 9 oppose each other in the third direction D3. The internal electrode 7 includes a region opposing the internal electrode 9 in the third direction D3. The internal electrode 9 includes a region opposing the internal electrode 7 in the third direction D3. The direction in which the internal electrode 7 and the internal electrode 9 oppose each other, that is, the third direction D3 is orthogonal to a direction parallel to the side surfaces 3c (first direction D1 and second direction D2).

As illustrated in FIG. 2, the internal electrode 7 includes a plurality of electrode portion 7a and 7b. For example, the internal electrode 7 includes a pair of electrode portion 7a and 7b. For example, when the electrode portion 7a includes a third electrode portion, the electrode portion 7b includes a fourth electrode portion.

The electrode portion 7a includes the end 7e₁. The electrode portion 7a has a width W₇ₐ. The width W₇ₐ includes a length, in the first direction D1, of the region included in the electrode portion 7a and opposing the internal electrode 9 in the third direction D3, for example. The electrode portion 7a is separated from the main surface 3a by a distance L₇ₐ₁. The distance L₇ₐ₁ includes a length in the first direction D1 between the electrode portion 7a and the main surface 3a, for example.

The electrode portion 7b includes the end 7e₂. The electrode portion 7b is closer to the end surface 3e to which the internal electrode 9 is exposed than the electrode portion 7a. The electrode portion 7b has a width W_{7b}. The width W_{7b} includes a length, in the first direction D1, of the electrode portion 7b, for example. The width W_{7b} is smaller than the width W₇ₐ. The electrode portion 7b is separated from the main surface 3a by a distance L₇ₐ₂. The distance L₇ₐ₂ includes a length in the first direction D1 between the electrode portion 7b and the main surface 3a, for example. The distance L₇ₐ₂ is larger than the distance L₇ₐ₁. The electrode portion 7b is farther from the main surface 3a in the first direction D1 than the electrode portion 7a. For example, when the width W₇ₐ includes a first width, the width W_{7b} includes a second width. For example, when the distance L₇ₐ₁ includes a first distance, the distance L₇ₐ₂ includes a second distance.

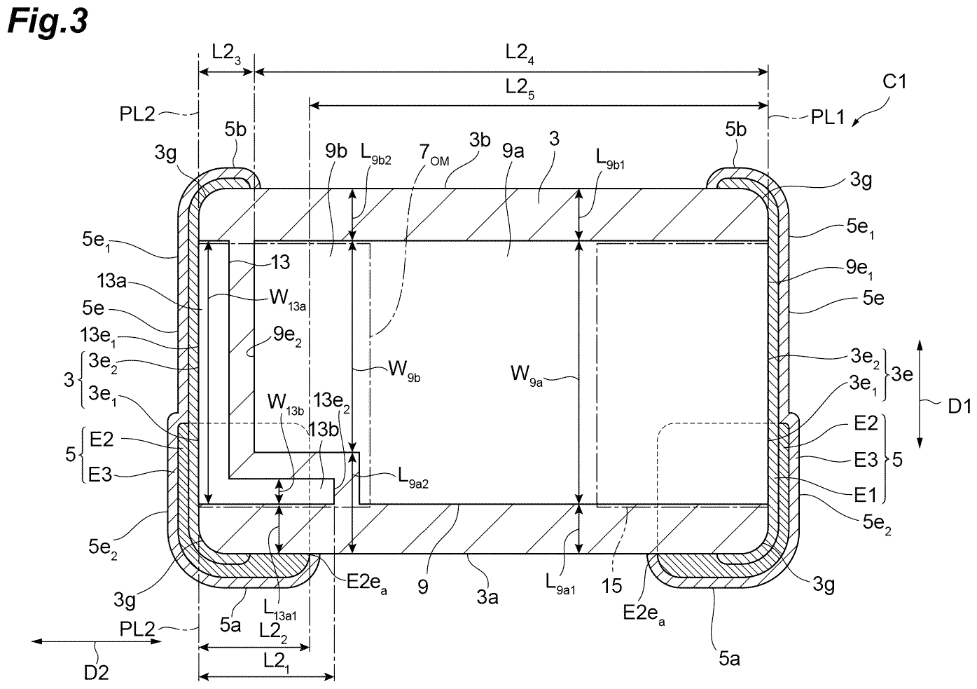

As illustrated in FIG. 3, the internal electrode 9 includes a plurality of electrode portion 9a and 9b. For example, the internal electrode 9 includes a pair of electrode portion 9a and 9b. For example, when the electrode portion 9a includes a third electrode portion, the electrode portion 9b includes a fourth electrode portion.

The electrode portion 9a includes the end 9e₁. The electrode portion 9a has a width W₉ₐ. The width W₉ₐ includes a length, in the first direction D1, of the region included in the electrode portion 9a and opposing the internal electrode 7 in the third direction D3, for example. The electrode portion 9a is separated from the main surface 3a by a distance L₉ₐ₁. The distance L₉ₐ₁ includes a length in the first direction D1 between the electrode portion 9a and the main surface 3a, for example. The width W₉ₐ may be equal to the width W₇ₐ or may be different from the width W₇ₐ. The distance L₉ₐ₁ may be equal to the distance L₇ₐ₁ or may be different from the distance L₇ₐ₁.

The electrode portion 9b includes the end 9e₂. The electrode portion 9b is closer to the end surface 3e to which the internal electrode 7 is exposed than the electrode portion 9a. The electrode portion 9b has a width W_{9b}. The width W_{9b} includes a length, in the first direction D1, of the electrode portion 9b, for example. The width W_{9b} is smaller than the width W₉ₐ. The electrode portion 9b is separated from the main surface 3a by a distance L₉ₐ₂. The distance L₉ₐ₂ includes a length in the first direction D1 between the electrode portion 9b and the main surface 3a, for example. The distance L₉ₐ₂ is larger than the distance L₉ₐ₁. The electrode portion 9b is farther from the main surface 3a in the first direction D1 than the electrode portion 9a. The width W_{9b} may be equal to the width W_{7b} or may be different from the width W_{7b}. The distance L_{9b2} may be equal to the distance L₇ₐ₂ or may be different from the distance L₇ₐ₂. For example, when the width W₉ₐ includes a first width, the width W_{9b} includes a second width. For example, when the distance L₉ₐ₁ includes a first distance, the distance L₉ₐ₂ includes a second distance.

The electrode portion 7a is separated from the main surface 3b by a distance L_{7b1}. The distance L_{7b1} includes a length in the first direction D1 between the electrode portion 7a and the main surface 3b, for example. The electrode portion 7b is separated from the main surface 3b by a distance L_{7b2}. The distance L_{7b2} includes a length in the first direction D1 between the electrode portion 7b and the main surface 3b, for example. For example, the distance L_{7b2} is substantially equal to the distance L_{7b1}.

The electrode portion 9a is separated from the main surface 3b by a distance L_{9b1}. The distance L_{9b1} includes a length in the first direction D1 between the electrode portion 9a and the main surface 3b, for example. The electrode portion 9b is separated from the main surface 3b by a distance L_{9b2}. The distance L_{9b2} includes a length in the first direction D1 between the electrode portion 9b and the main surface 3b, for example. For example, the distance L_{9b2} is substantially equal to the distance L_{9b1}. The distance L_{9b1} may be equal to the distance L_{7b1} or may be different from the distance L_{7b1}. The distance L_{9b2} may be equal to the distance L_{7b2} or may be different from the distance L_{7b2}.

The plurality of internal electrode 7 include, for example, one internal electrode 7_{OM} positioned on the outermost side in the third direction D3. The internal electrode 7_{OM} is adjacent to one side surface 3c of the pair of side surface 3c in the third direction D3. The internal electrode 7_{OM} is closest to the one side surface 3c among the plurality of internal electrodes 7. The internal electrode 7_{OM} includes an outermost internal electrode.

The plurality of internal electrode 9 include, for example, one internal electrode 9_{OM} positioned on the outermost side in the third direction D3. The internal electrode 9_{OM} is adjacent to an other side surface 3c of the pair of side surface 3c in the third direction D3. The internal electrode 9_{OM} is closest to the other side surface 3c among the plurality of internal electrodes 9. The internal electrode 9_{OM} includes an outermost internal electrode.

As illustrated in FIGS. 2 to 5, the multilayer capacitor C1 includes a plurality of auxiliary internal electrodes 11 and a plurality of auxiliary internal electrodes 13. Each of the auxiliary internal electrodes 11 and 13 is included in an internal conductor disposed in the element body 3. Similar to the internal electrodes 7 and 9, the auxiliary internal electrodes 11 and 13 are made of an electrically conductive material that is commonly used as an internal conductor of a multilayer electronic component. The electrically conductive material includes, for example, a base metal. The electrically conductive material includes, for example, Ni or Cu. Each of the auxiliary internal electrodes 11 and 13 is configured as a sintered body of an electrically conductive paste containing the electrically conductive material described above. For example, the auxiliary internal electrodes 11 and 13 are made of Ni.

Each of the plurality of auxiliary internal electrodes 11 is disposed in the same layer as a corresponding internal electrode 7 of the plurality of internal electrodes 7. Each of the plurality of auxiliary internal electrodes 11 is disposed between the corresponding internal electrode 7 and the end surface 3e to which the internal electrode 7 is not exposed. For example, one internal electrode 7 and one auxiliary internal electrode 11 are positioned in the same layer. One internal electrode 7 and one auxiliary internal electrode 11 oppose each other in the second direction D2, in the same layer. The internal electrode 7 and the auxiliary internal electrode 11 that are disposed in the same layer are separated from each other in the second direction D2. The auxiliary internal electrodes 11 are separated from the main surfaces 3a and 3b and are not exposed to the main surfaces 3a and 3b.

As illustrated in FIG. 2, the auxiliary internal electrode 11 includes a plurality of electrode portions 11a and 11b. For example, the auxiliary internal electrode 11 includes a pair of electrode portions 11a and 11b. For example, when the electrode portion 11a includes a first electrode portion, the electrode portion 11b includes a second electrode portion.

The electrode portion 11a is exposed to a corresponding end surface 3e of the pair of end surfaces 3e. The electrode portion 11a is exposed to the end surface 3e to which the internal electrode 7 is not exposed. The electrode portion 11a includes an end 11e₁ exposed to the end surface 3e to which the internal electrode 7 is not exposed.

The electrode portion 11a is directly connected to the electrode portion 5e included in a corresponding external electrode 5 of the pair of external electrodes 5, at the end 11e₁. The electrode portion 11a is electrically and physically connected to the electrode portion 5e included in the corresponding external electrode 5. The electrode portion 5e to which the electrode portion 11a is electrically and physically connected is different from the electrode portion 5e to which the internal electrode 7 is electrically and physically connected. The internal electrode 7 is not electrically connected to the electrode portion 5e to which the electrode portion 11a is electrically and physically connected. The electrode portion 11a is electrically and physically connected to the external electrode 5 to which the internal electrode 7 is not electrically connected.

The electrode portion 11b is positioned between the internal electrode 7 and the second electrode layer E2 included in the electrode portion 5a of the external electrode 5 that is not electrically and physically connected to the internal electrode 7 positioned in the same layer. The electrode portion 11b is positioned between the electrode portion 7b included in the internal electrode 7 positioned in the same layer and the second electrode layer E2 of the electrode portion 5a, in the first direction D1. The electrode portion 7b and the electrode portion 11b that are positioned in the same layer are separated from each other in the first direction D1. The electrode portion 7a and the electrode portion 11b that are positioned in the same layer are separated from each other in the second direction D2.

The electrode portion 11a has a width W₁₁ₐ. The electrode portion 11a is exposed to the end surface 3e to which the internal electrode 7 is not exposed with a width W₁₁ₐ. The width W₁₁ₐ includes, for example, a length of the electrode portion 11a in the first direction D1. The electrode portion 11b has a width W_{11b}. The width W_{11b} includes, for example, a length of the electrode portion 11b in the first direction D1. The width W₁₁ₐ is larger than the width W_{11b}.

The electrode portion 11b is separated from the main surface 3a by a distance L₁₁ₐ₁. The distance L₁₁ₐ₁ includes, for example, a length in the first direction D1 between the electrode portion 11b and the main surface 3a. The distance L₁₁ₐ₁ may be equal to the distance L₇ₐ₁ or may be different from the distance L₇ₐ₁.

The electrode portion 11b includes an end 11e₂ opposing the end 11e₁ in the second direction D2. The end 11e₂ is positioned in the element body 3. The end 11e₂ is closer to the end surface 3e to which the internal electrode 7 is exposed than the end 11e₁. The auxiliary internal electrode 11 includes a pair of ends 11e₁ and 11e₂ opposing each other in the second direction D2.

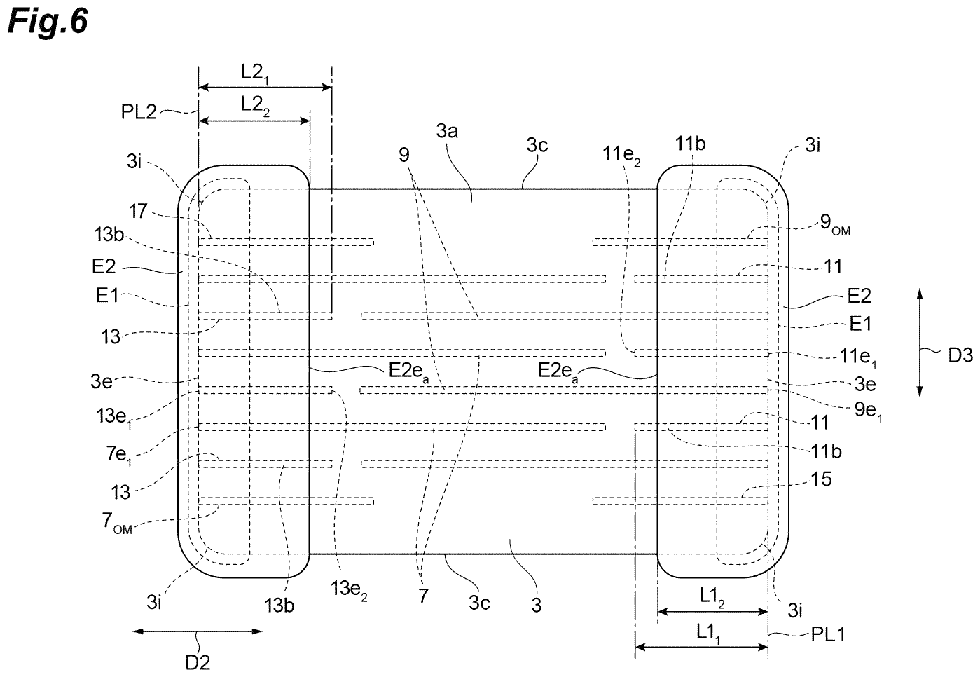

The auxiliary internal electrode 11 and the second electrode layer E2 of the electrode portion 5a that are electrically connected to each other have a relationship in which a length L1₁ from a reference surface PL1 to the end 11e₂ is larger than a length L1₂ from the reference surface PL1 to the end edge E2eₐ. The reference surface PL1 includes the end surface 3e to which the auxiliary internal electrode 11 (end 11e₁) is exposed. The length L1₁ includes a maximum length of the auxiliary internal electrode 11 in the second direction D2. As illustrated in FIG. 6, when the auxiliary internal electrode 11 and the second electrode layer E2 of the electrode portion 5a electrically connected to the auxiliary internal electrode 11 are viewed from the first direction D1, the electrode portion 11b includes a portion exposed from the second electrode layer E2 of the electrode portion 5a electrically connected to the auxiliary internal electrode 11. FIG. 6 is a view illustrating a relationship among an internal electrode, an auxiliary internal electrode, and a second electrode layer.

The internal electrode 7 and the auxiliary internal electrode 11 that are disposed in the same layer have a relationship in which a length of the auxiliary internal electrode 11 from the reference plane PL1 is larger than a length from the reference plane PL1 to the internal electrode 7. The length of the auxiliary internal electrode 11 from the reference plane PL1 is defined by, for example, a maximum length of the auxiliary internal electrode 11 in the second direction D2. That is, the length of the auxiliary internal electrode 11 from the reference plane PL1 is defined by, for example, the length L1₁. The length from the reference plane PL1 to the internal electrode 7 is defined by, for example, a minimum length L1₃ in the second direction D2 from the reference plane PL1 to the internal electrode 7.

The internal electrode 7 and the second electrode layer E2 of the electrode portion 5a that are not electrically connected to each other have a relationship in which a length of the internal electrode 7 from a reference plane PL2 is larger than a length from the reference plane PL2 to the and edge E2eₐ of the second electrode layer E2 of the electrode portion 5a that is not electrically connected to the internal electrode 7. The length of the internal electrode 7 from the reference plane PL2 is defined by, for example, a maximum length L1₄ of the internal electrode 7 in the second direction D2. The length from the reference plane PL2 to the above-described end edge E2eₐ is defined by, for example, a length L1₅ from the reference plane PL2 to the above-described end edge E2eₐ in the second direction D2. The reference surface PL2 includes the end surface 3e to which the internal electrode 7 (end 7e₁) is exposed.

Each of the plurality of auxiliary internal electrodes 13 is disposed in the same layer as a corresponding internal electrode 9 of the plurality of internal electrodes 9. Each of the plurality of auxiliary internal electrodes 13 is disposed between the corresponding internal electrode 9 and the end surface 3e to which the internal electrode 9 is not exposed. For example, one internal electrode 9 and one auxiliary internal electrode 13 are positioned in the same layer. One internal electrode 9 and one auxiliary internal electrode 13 oppose each other in the second direction D2, in the same layer. The internal electrode 9 and the auxiliary internal electrode 13 that are disposed in the same layer are separated from each other in the second direction D2. The auxiliary internal electrodes 13 are separated from the main surfaces 3a and 3b and are not exposed to the main surfaces 3a and 3b.

As illustrated in FIG. 3, the auxiliary internal electrode 13 includes a plurality of electrode portions 13a and 13b. For example, the auxiliary internal electrode 13 includes a pair of electrode portions 13a and 13b. For example, when the electrode portion 13a includes a first electrode portion, the electrode portion 13b includes a second electrode portion.

The electrode portion 13a is exposed to a corresponding end surface 3e of the pair of end surfaces 3e. The electrode portion 13a is exposed to the end surface 3e to which the internal electrode 9 is not exposed. The electrode portion 13a includes an end 13e₁ exposed to the end surface 3e to which the internal electrode 9 is not exposed.

The electrode portion 13a is directly connected to the electrode portion 5e included in a corresponding external electrode 5 of the pair of external electrodes 5, at the end 13e₁. The electrode portion 13a is electrically and physically connected to the electrode portion 5e included in the corresponding external electrode 5. The electrode portion 5e to which the electrode portion 13a is electrically and physically connected is different from the electrode portion 5e to which the internal electrode 9 is electrically and physically connected. The internal electrode 9 is not electrically connected to the electrode portion 5e to which the electrode portion 13a is electrically and physically connected. The electrode portion 13a is electrically and physically connected to the external electrode 5 to which the internal electrode 9 is not electrically connected.

The electrode portion 13b is positioned between the internal electrode 9 and the second electrode layer E2 included in the electrode portion 5a of the external electrode 5 that is not electrically and physically connected to the internal electrode 9 positioned in the same layer. The electrode portion 13b is positioned between the electrode portion 9b included in the internal electrode 9 positioned in the same layer and the second electrode layer E2 of the electrode portion 5a, in the first direction D1. The electrode portion 9b and the electrode portion 13b that are positioned in the same layer are separated from each other in the first direction D1. The electrode portion 9a and the electrode portion 13b that are positioned in the same layer are separated from each other in the second direction D2.

The electrode portion 13a has a width W₁₃ₐ. The electrode portion 13a is exposed to the end surface 3e to which the internal electrode 9 is not exposed with a width W₁₃ₐ. The width W₁₃ₐ includes, for example, a length of the electrode portion 13a in the first direction D1. The electrode portion 13b has a width W_{13b}. The width W_{13b} includes, for example, a length of the electrode portion 13b in the first direction D1. The width W₁₃ₐ is larger than the width W_{13b}.

The electrode portion 13b is separated from the main surface 3a by a distance L₁₃ₐ₁. The distance L₁₃ₐ₁ includes, for example, a length in the first direction D1 between the electrode portion 13b and the main surface 3a. The distance L₁₃ₐ₁ may be equal to the distance L₉ₐ₁ or may be different from the distance L₉ₐ₁.

The electrode portion 13b includes an end 13e₂ opposing the end 13e₁ in the second direction D2. The end 13e₂ is positioned in the element body 3. The end 13e₂ is closer to the end surface 3e to which the internal electrode 9 is exposed than the end 13e₁. The auxiliary internal electrode 13 includes a pair of ends 13e₁ and 13e₂ opposing each other in the second direction D2.

The auxiliary internal electrode 13 and the second electrode layer E2 of the electrode portion 5a that are electrically connected to each other have a relationship in which a length L2₁ from the reference surface PL2 to the end 13e₂ is larger than a length L2₂ from the reference surface PL2 to the end edge E2eₐ. The reference surface PL2 includes the end surface 3e to which the auxiliary internal electrode 13 (end 13e₁) is exposed. The length L2₁ includes a maximum length of the auxiliary internal electrode 13 in the second direction D2. As illustrated in FIG. 6, when the auxiliary internal electrode 13 and the second electrode layer E2 of the electrode portion 5a electrically connected to the auxiliary internal electrode 13 are viewed from the first direction D1, the electrode portion 13b includes a portion exposed from the second electrode layer E2 of the electrode portion 5a electrically connected to the auxiliary internal electrode 13.

The internal electrode 9 and the auxiliary internal electrode 13 that are disposed in the same layer have a relationship in which a length of the auxiliary internal electrode 13 from the reference plane PL2 is larger than a length from the reference plane PL2 to the internal electrode 9. The length of the auxiliary internal electrode 13 from the reference plane PL2 is defined by, for example, a maximum length of the auxiliary internal electrode 13 in the second direction D2. That is, the length of the auxiliary internal electrode 13 from the reference plane PL2 is defined by, for example, the length L2₁. The length from the reference plane PL2 to the internal electrode 9 is defined by, for example, a minimum length L2₃ in the second direction D2 from the reference plane PL2 to the internal electrode 9.

The internal electrode 9 and the second electrode layer E2 of the electrode portion 5a that are not electrically connected to each other have a relationship in which a length of the internal electrode 9 from the reference plane PL1 is larger than a length from the reference plane PL1 to the and edge E2eₐ of the second electrode layer E2 of the electrode portion 5a that is not electrically connected to the internal electrode 9. The length of the internal electrode 9 from the reference plane PL1 is defined by, for example, a maximum length L2₄ of the internal electrode 9 in the second direction D2. The length from the reference plane PL1 to the above-described end edge E2eₐ is defined by, for example, a length L2₅ from the reference plane PL1 to the above-described end edge E2eₐ in the second direction D2. The reference surface PL1 includes the end surface 3e to which the internal electrode 9 (end 9e₁) is exposed.

The internal electrode 7_{OM} is adjacent to the second electrode layer E2 of the electrode portion 5c electrically connected to the internal electrode 7_{OM}, in the third direction D3. The internal electrode 7_{OM} opposes the electrode portion 9b in the third direction D3. When viewed from the third direction D3, the internal electrode 7_{OM} does not overlap the second electrode layer E2 of the electrode portion 5c that is not electrically connected to the internal electrode 7_{OM}. When viewed from the third direction D3, the internal electrode 7_{OM} does not overlap the second electrode layer E2 of the electrode portion 5c electrically connected to the internal electrode 9. When the internal electrode 7_{OM} and the second electrode layer E2 of the electrode portion 5c electrically connected to the auxiliary internal electrode 11 are viewed from the third direction D3, the internal electrode 7_{OM} and the second electrode layer E2 of the electrode portion 5c electrically connected to the auxiliary internal electrode 11 are separated from each other in the second direction D2.

The internal electrode 9_{OM} is adjacent to the second electrode layer E2 of the electrode portion 5c electrically connected to the internal electrode 9_{OM}, in the third direction D3. The internal electrode 9_{OM} opposes the electrode portion 7b in the third direction D3. When viewed from the third direction D3, the internal electrode 9_{OM} does not overlap the second electrode layer E2 of the electrode portion 5c that is not electrically connected to the internal electrode 9_{OM}. When viewed from the third direction D3, the internal electrode 9_{OM} does not overlap the second electrode layer E2 of the electrode portion 5c electrically connected to the internal electrode 7. When the internal electrode 9_{OM} and the second electrode layer E2 of the electrode portion 5c electrically connected to the auxiliary internal electrode 13 are viewed from the third direction D3, the internal electrode 9_{OM} and the second electrode layer E2 of the electrode portion 5c electrically connected to the auxiliary internal electrode 13 are separated from each other in the second direction D2.

As illustrated in FIGS. 2 to 5, the multilayer capacitor C1 includes a plurality of conductors 15 and 17. For example, the multilayer capacitor C1 includes two conductors 15 and 17. In FIGS. 2 and 3, for the sake of explanation, the internal electrodes 7 and 9 (internal electrodes 7_{OM} and 9_{OM}) and the conductors 15 and 17 are intentionally illustrated so as to deviate from each other in the first direction D1.

The conductor 15 is positioned in the same layer as the internal electrode 7_{OM} and is separated from the internal electrode 7_{OM}. The conductor 15 includes one end exposed to the corresponding end surface 3e. The one end of the conductor 15 is exposed to the end surface 3e to which the internal electrode 9 (end 9e₁) is exposed. The one end of the conductor 15 is entirely covered by the corresponding electrode portion 5e. The conductor 15 is directly connected to the corresponding electrode portion 5e. The conductor 15 is electrically connected to the corresponding external electrode 5. In the multilayer capacitor C1, the conductor 15 is electrically connected to the external electrode 5 (electrode portion 5e) to which the internal electrode 9 is electrically connected. The conductor 15 is electrically connected to the external electrode 5 to which the internal electrode 7 is not electrically connected.

The conductor 17 is positioned in the same layer as the internal electrode 9_{OM} and is separated from the internal electrode 9_{OM}. The conductor 17 includes one end exposed to the corresponding end surface 3e. The one end of the conductor 15 is exposed to the end surface 3e to which the internal electrode 7 (end 7e₁) is exposed. The one end of the conductor 17 is entirely covered by the corresponding electrode portion 5e. The conductor 17 is directly connected to the corresponding electrode portion 5e. The conductor 17 is electrically connected to the corresponding external electrode 5. In the multilayer capacitor C1, the conductor 17 is electrically connected to the external electrode 5 (electrode portion 5e) to which the internal electrode 7 is electrically connected. The conductor 17 is electrically connected to the external electrode 5 to which the internal electrode 9 is not electrically connected.

The conductor 15 opposes the internal electrode 9 and does not opposes the internal electrode 7, in the third direction D3. The conductor 17 opposes the internal electrode 7 and does not opposes the internal electrode 9, in the third direction D3. Each of the conductors 15 and 17 includes a dummy conductor that tends not to contribute to generation of capacitance.

When the multilayer capacitor C1 is solder-mounted on an electronic device, an external force acting on the multilayer capacitor C1 from the electronic device may act on the element body 3 through the external electrode 5. The external force is transmitted to the external electrode 5 from the solder fillet formed in solder-mounting. The electronic device includes, for example, a circuit board or an electronic component.

In the multilayer capacitor C1, the external electrode 5 includes the second electrode layer E2. Therefore, the external force tends not to act on the element body 3 from the external electrode 5. Consequently, the multilayer capacitor C1 prevents cracks from occurring in the element body 3.

In the multilayer capacitor C1, the auxiliary internal electrode 11 is electrically connected to the external electrode 5 to which the corresponding internal electrode 7 is not electrically connected. The electrode portion 11b is positioned between the second electrode layer E2 included in the electrode portion 5a of the external electrode 5 to which the auxiliary internal electrode 11 is electrically connected and the internal electrode 7 in the same layer as the auxiliary internal electrode 11. The electrode portion 11b is positioned between the second electrode layer E2 of the electrode portion 5a and the internal electrode 7 that are not electrically connected to each other. Therefore, electric field tends not to be generated between the second electrode layer E2 of the electrode portion 5a and the internal electrode 7 that are not electrically connected to each other.

In the multilayer capacitor C1, the auxiliary internal electrode 13 is electrically connected to the external electrode 5 to which the corresponding internal electrode 9 is not electrically connected. The electrode portion 13b is positioned between the second electrode layer E2 included in the electrode portion 5a of the external electrode 5 to which the auxiliary internal electrode 13 is electrically connected and the internal electrode 9 in the same layer as the auxiliary internal electrode 13. The electrode portion 13b is positioned between the second electrode layer E2 of the electrode portion 5a and the internal electrode 9 that are not electrically connected to each other. Therefore, electric field tends not to be generated between the second electrode layer E2 of the electrode portion 5a and the internal electrode 9 that are not electrically connected to each other.

Consequently, the multilayer capacitor C1 reduces occurrence of migration.

In the multilayer capacitor C1, the electrode portion 11a is exposed to the end surface 3e with the width W₁₁ₐ larger than the width W_{11b} of the electrode portion 11b. The multilayer capacitor C1 increases a physical connection length between the electrode portion 11a and the external electrode 5, as compared with, for example, a configuration in which the width W₁₁ₐ is the same as the width W_{11b}. Therefore, the multilayer capacitor C1 improves connectivity between the external electrode 5 and the auxiliary internal electrode 11.

In the multilayer capacitor C1, the electrode portion 13a is exposed to the end surface 3e with the width W₁₃ₐ larger than the width W_{13b} of the electrode portion 13b. The multilayer capacitor C1 increases a physical connection length between the electrode portion 13a and the external electrode 5, as compared with, for example, a configuration in which the width W₁₃ₐ is the same as the width W_{13b}. Therefore, the multilayer capacitor C1 improves connectivity between the external electrode 5 and the auxiliary internal electrode 13.

A configuration in which the auxiliary internal electrode 11 is disposed in the same layer as the internal electrode 7 tends to decrease an area of the internal electrode 7. A decrease in the area of the internal electrode 7 may lead to a decrease in capacitance.

In the multilayer capacitor C1, the internal electrode 7 includes the electrode portion 7a including the end 7e₁ and the electrode portion 7b including the end 7e₂. The electrode portion 7a has the width W₇ₐ and is separated from the main surface 3a by the distance L₇ₐ₁. The electrode portion 7b has the width W_{7b} and is separated from the main surface 3a by the distance L₇ₐ₂. The electrode portion 11b is positioned between the second electrode layer E2 of the electrode portion 5a to which the internal electrode 7 is not electrically connected and the electrode portion 7b. Therefore, the multilayer capacitor C1 prevents a decrease in an area of the internal electrode 7.

A configuration in which the auxiliary internal electrode 13 is disposed in the same layer as the internal electrode 9 tends to decrease an area of the internal electrode 9. A decrease in the area of the internal electrode 9 may lead to a decrease in capacitance.

In the multilayer capacitor C1, the internal electrode 9 includes the electrode portion 9a including the end 9e₁ and the electrode portion 9b including the end 9e₂. The electrode portion 9a has the width W₉ₐ and is separated from the main surface 3a by the distance L₉ₐ₁. The electrode portion 9b has the width W_{9b} and is separated from the main surface 3a by the distance L₉ₐ₂. The electrode portion 13b is positioned between the second electrode layer E2 of the electrode portion 5a to which the internal electrode 9 is not electrically connected and the electrode portion 9b. Therefore, the multilayer capacitor C1 prevents a decrease in an area of the internal electrode 9.

In the multilayer capacitor C1, the auxiliary internal electrode 11 and the second electrode layer E2 of the electrode portion 5a that are electrically connected to each other have a relationship in which the length L1₁ from the reference plane PL1 to the end 11e₂ is larger than the length L1₂ from the reference plane PL1 to the end edge E2eₐ. Therefore, the electric field tends not to be reliably generated between the second electrode layer E2 of the electrode portion 5a and the internal electrode 7 that are not electrically connected to each other.

In the multilayer capacitor C1, the auxiliary internal electrode 13 and the second electrode layer E2 of the electrode portion 5a that are electrically connected to each other have a relationship in which the length L2₁ from the reference plane PL2 to the end 13e₂ is larger than the length L2₂ from the reference plane PL2 to the end edge E2eₐ. Therefore, the electric field tends not to be reliably generated between the second electrode layer E2 of the electrode portion 5a and the internal electrode 9 that are not electrically connected to each other.

Consequently, the multilayer capacitor C1 reliably reduces the occurrence of the migration.

In the multilayer capacitor C1, when the auxiliary internal electrode 11 and the second electrode layer E2 of the electrode portion 5a electrically connected to the auxiliary internal electrode 11 are viewed from the first direction D1, the electrode portion 11b includes the portion exposed from the second electrode layer E2 of the electrode portion 5a electrically connected to the auxiliary internal electrode 11. Therefore, the electric field tends not to be reliably generated between the second electrode layer E2 of the electrode portion 5a and the internal electrode 7 that are not electrically connected to each other.

In the multilayer capacitor C1, when the auxiliary internal electrode 13 and the second electrode layer E2 of the electrode portion 5a electrically connected to the auxiliary internal electrode 13 are viewed from the first direction D1, the electrode portion 13b includes the portion exposed from the second electrode layer E2 of the electrode portion 5a electrically connected to the auxiliary internal electrode 13. Therefore, the electric field tends not to be reliably generated between the second electrode layer E2 of the electrode portion 5a and the internal electrode 9 that are not electrically connected to each other.

Consequently, the multilayer capacitor C1 reliably reduces the occurrence of the migration.

In the multilayer capacitor C1, the internal electrode 7 and the auxiliary internal electrode 11 that are disposed in the same layer have a relationship in which the length of the auxiliary internal electrode 11 from the reference plane PL1 is larger than the length from the reference plane PL1 to the internal electrode 7. Therefore, the electric field tends not to be reliably generated between the second electrode layer E2 of the electrode portion 5a and the internal electrode 7 that are not electrically connected to each other.

In the multilayer capacitor C1, the internal electrode 9 and the auxiliary internal electrode 13 that are disposed in the same layer have a relationship in which the length of the auxiliary internal electrode 13 from the reference plane PL2 is larger than the length from the reference plane PL2 to the internal electrode 9. Therefore, the electric field tends not to be reliably generated between the second electrode layer E2 of the electrode portion 5a and the internal electrode 9 that are not electrically connected to each other.

Consequently, the multilayer capacitor C1 reliably reduces the occurrence of the migration.

In the multilayer capacitor C1, the internal electrode 7 and the auxiliary internal electrode 11 that are disposed in the same layer have a relationship in which the length from the reference plane PL1 to the internal electrode 7 is smaller than the length of the auxiliary internal electrode 11 from the reference plane PL1. The multilayer capacitor C1 can increase a length of the internal electrode 7 in the second direction D2. Therefore, the multilayer capacitor C1 can increase capacitance.

In the multilayer capacitor C1, the internal electrode 9 and the auxiliary internal electrode 13 that are disposed in the same layer have a relationship in which the length from the reference plane PL2 to the internal electrode 9 is smaller than the length of the auxiliary internal electrode 13 from the reference plane PL2. The multilayer capacitor C1 can increase a length of the internal electrode 9 in the second direction D2. Therefore, the multilayer capacitor C1 can increase capacitance.

In the multilayer capacitor C1, the internal electrode 7 and the second electrode layer E2 of the electrode portion 5a that are not electrically connected to each other have a relationship in which the length of the internal electrode 7 from the reference plane PL2 is larger than the length from the reference plane PL2 to the end edge E2eₐ of the second electrode layer E2 of the electrode portion 5a not electrically connected to the internal electrode 7. The multilayer capacitor C1 can increase a length of the internal electrode 7 in the second direction D2. Therefore, the multilayer capacitor C1 can increase capacitance.

In the multilayer capacitor C1, the internal electrode 9 and the second electrode layer E2 of the electrode portion 5a that are not electrically connected to each other have a relationship in which the length of the internal electrode 9 from the reference plane PL1 is larger than the length from the reference plane PL1 to the end edge E2eₐ of the second electrode layer E2 of the electrode portion 5a not electrically connected to the internal electrode 9. The multilayer capacitor C1 can increase a length of the internal electrode 9 in the second direction D2. Therefore, the multilayer capacitor C1 can increase capacitance.

In the multilayer capacitor C1, the internal electrode 7_{OM} does not overlap the second electrode layer E2 of the electrode portion 5c not electrically connected to the internal electrode 7_{OM} when viewed from the third direction D3. Therefore, electric field tends not to be generated between the internal electrode 7_{OM} and the second electrode layer E2 of the electrode portion 5c that are not electrically connected to each other.

In the multilayer capacitor C1, the internal electrode 9_{OM} does not overlap the second electrode layer E2 of the electrode portion 5c not electrically connected to the internal electrode 9_{OM} when viewed from the third direction D3. Therefore, electric field tends not to be generated between the internal electrode 9_{OM} and the second electrode layer E2 of the electrode portion 5c that are not electrically connected to each other.

Consequently, the multilayer capacitor C1 reduces the occurrence of migration even in a configuration in which the electrode portion 5c of the external electrode 5 includes the second electrode layer E2.

In the multilayer capacitor C1, when the second electrode layer E2 positioned on the end surface 3e and the end surface 3e are viewed from the second direction D2, the end surface 3e includes the region 3e₁ covered with the second electrode layer E2 positioned on the end surface 3e and the region 3e₂ exposed from the second electrode layer E2 positioned on the end surface 3e. The region 3e₂ is closer to the main surface 3b than the region 3e₁.

The multilayer capacitor C1 reduces ESR, as compared with a configuration in which the second electrode layer E2 covers the entire end surface 3e.

The second electrode layer E2 includes the plurality of silver particles. The silver particle tends to cause migration than, for example, copper particle.

The multilayer capacitor C1 reliably reduces the occurrence of the migration even in a configuration in which the second electrode layer E2 includes the plurality of silver particles.

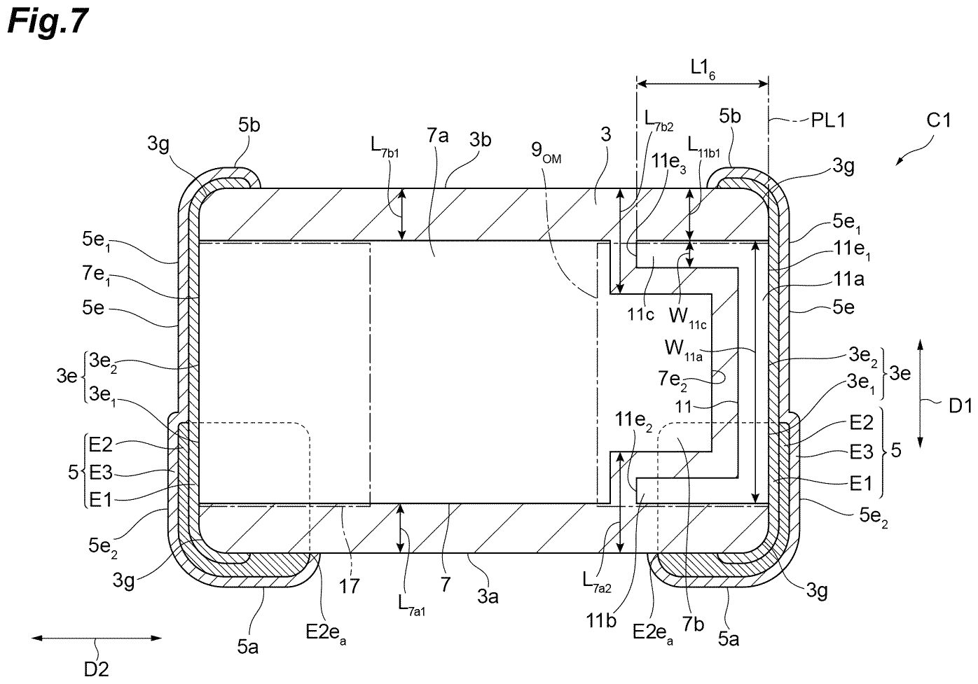

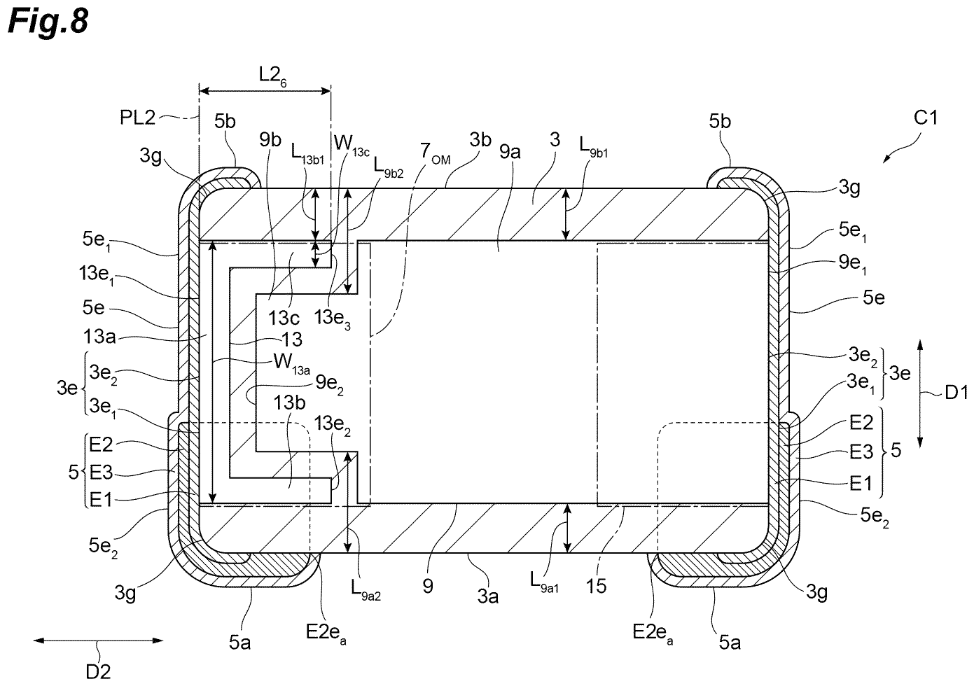

Next, a configuration of a multilayer capacitor according to a modified example of the first example will be described with reference to FIGS. 7 and 8. FIGS. 7 and 8 are views illustrating a cross-sectional configuration of a multilayer capacitor according to the modified example of the first example. The multilayer capacitor according to the modified example is generally similar to or the same as the above-described multilayer capacitor C1. However, the modified example is different from the above-described first example in a configuration of the internal electrodes 7 and 9 and the auxiliary internal electrodes 11 and 13. Hereinafter, differences between the above-described first example and the modified example will be mainly described.

In FIG. 7, the lengths L1₁, L1₂, L1₃, L1₄, and L1₅, the distance L₁₁ₐ₁, and the widths W₇ₐ, W_{7b}, and W_{11b} illustrated in FIG. 2 are omitted. The lengths L1₁, L1₂, L1₃, L1₄, and L1₅, the distance L₁₁ₐ₁, and the widths W₇ₐ, W_{7b}, and W_{11b} are defined in the same manner as in the above-described first example.

In FIG. 8, the lengths L2₁, L2₂, L2₃, L2₄, and L2₅, the distance L₁₃ₐ₁, and the widths W₉ₐ, W_{9b}, and W_{13b} illustrated in FIG. 3 are omitted. The lengths L2₁, L2₂, L2₃, L2₄, and L2₅, the distance L₁₃ₐ₁, and the widths W₉ₐ, W_{9b}, and W_{13b} are defined in the same manner as in the above-described first example.

As illustrated in FIG. 7, the distance L_{7b2} is larger than the distance L_{7b1}. The electrode portion 7b is farther from the main surface 3b in the first direction D1 than the electrode portion 7a. The distance L_{7b2} is, for example, substantially equal to the distance L₇ₐ₂. The distance L_{7b2} may be different from the distance L₇ₐ₂.

As illustrated in FIG. 8, the distance L_{9b2} is larger than the distance L_{9b1}. The electrode portion 9b is farther from the main surface 3b in the first direction D1 than the electrode portion 9a. The distance L_{9b2} is, for example, substantially equal to the distance L₉ₐ₂. The distance L_{9b2} may be different from the distance L₉ₐ₂.

As illustrated in FIG. 7, the auxiliary internal electrode 11 includes an electrode portion 11c. The electrode portion 11c and the electrode portion 11b are separated from each other in the first direction D1. The electrode portion 11c is positioned between the internal electrode 7 positioned in the same layer and the main surface 3b. The electrode portion 11c is positioned between the main surface 3b and the electrode portion 7b included in the internal electrode 7 positioned in the same layer, in the first direction D1. The electrode portion 7b is positioned between the electrode portion 11c and the electrode portion 11b, in the first direction D1. The electrode portion 7b and the electrode portion 11c that are positioned in the same layer are separated from each other in the first direction D1. The electrode portion 7a and the electrode portion 11c that are positioned in the same layer are separated from each other in the second direction D2.

The electrode portion 11c has a width W_{11c}. The width W_{11c} is, for example, a length of the electrode portion 11c in the first direction D1. The width W₁₁ₐ is greater than the width W_{11c}. The width W_{11c} is substantially equal to the width W_{11b}, for example. The width W_{11c} may be different from the width W_{11b}.

The electrode portion 11c is separated from the main surface 3b by a distance L_{11b1}. The distance L_{11b1} includes, for example, a length in the first direction D1 between the electrode portion 11c and the main surface 3b. The distance L_{11b1} may be equal to the distance L_{7b1} or may be different from the distance L_{7b1}.

The electrode portion 11c includes an end 11e₃ opposing the end 11e₁ in the second direction D2. The end 11e₃ is positioned in the element body 3. The end 11e₃ is closer to the end surface 3e to which the internal electrode 7 is exposed than the end 11e₁.

A length L1₆ from the reference plane PL1 to the end 11e₃ is substantially equal to the length L1₁, for example. The length L1₆ may be different from the length L1₁. The length L1₆ is, for example, greater than the length L1₂.

As illustrated in FIG. 8, the auxiliary internal electrode 13 includes an electrode portion 13c. The electrode portion 13c and the electrode portion 13b are separated from each other in the first direction D1. The electrode portion 13c is positioned between the internal electrode 9 positioned in the same layer and the main surface 3b. The electrode portion 13c is positioned between the main surface 3b and the electrode portion 9b included in the internal electrode 9 positioned in the same layer, in the first direction D1. The electrode portion 9b is positioned between the electrode portion 13c and the electrode portion 13b, in the first direction D1. The electrode portion 9b and the electrode portion 13c that are positioned in the same layer are separated from each other in the first direction D1. The electrode portion 9a and the electrode portion 13c that are positioned in the same layer are separated from each other in the second direction D2.

The electrode portion 13c has a width W_{13c}. The width W_{13c} is, for example, a length of the electrode portion 13c in the first direction D1. The width W₁₃ₐ is greater than the width W_{13c}. The width W_{13c} is substantially equal to the width W_{13b}, for example. The width W_{13c} may be different from the width W_{13b}.

The electrode portion 13c is separated from the main surface 3b by a distance L_{13b1}. The distance L_{13b1} includes, for example, a length in the first direction D1 between the electrode portion 13c and the main surface 3b. The distance L_{13b1} may be equal to the distance L_{9b1} or may be different from the distance L_{9b1}.

The electrode portion 13c includes an end 13e₃ opposing the end 13e₁ in the second direction D2. The end 13e₃ is positioned in the element body 3. The end 13e₃ is closer to the end surface 3e to which the internal electrode 9 is exposed than the end 13e₁.

A length L2₆ from the reference plane PL2 to the end 13e₃ is substantially equal to the length L2₁, for example. The length L2₆ may be different from the length L2₁. The length L2₆ is, for example, greater than the length L2₂.

In this modification, the element body 3 has no directionality in the first direction D1 at forming the external electrode 5 on the element body 3. That is, the external electrode 5 (second electrode layer E2) may be formed on the element body 3 so that the main surface 3a constitutes the mounting surface, or may be formed on the element body 3 so that the main surface 3b constitutes the mounting surface. The second electrode layer E2 is formed to continuously cover only a part of the main surface 3b, only a part of the end surface 3e, and only a part of each of the pair of side surfaces 3c at forming the external electrode 5 on the element body 3 so that the main surface 3b constitutes the mounting surface.

The multilayer capacitor C1 reduces occurrence of migration even in a configuration in which the external electrode 5 (second electrode layer E2) is formed on the element body 3 so that the main surface 3b constitutes the mounting surface.

### Second Example

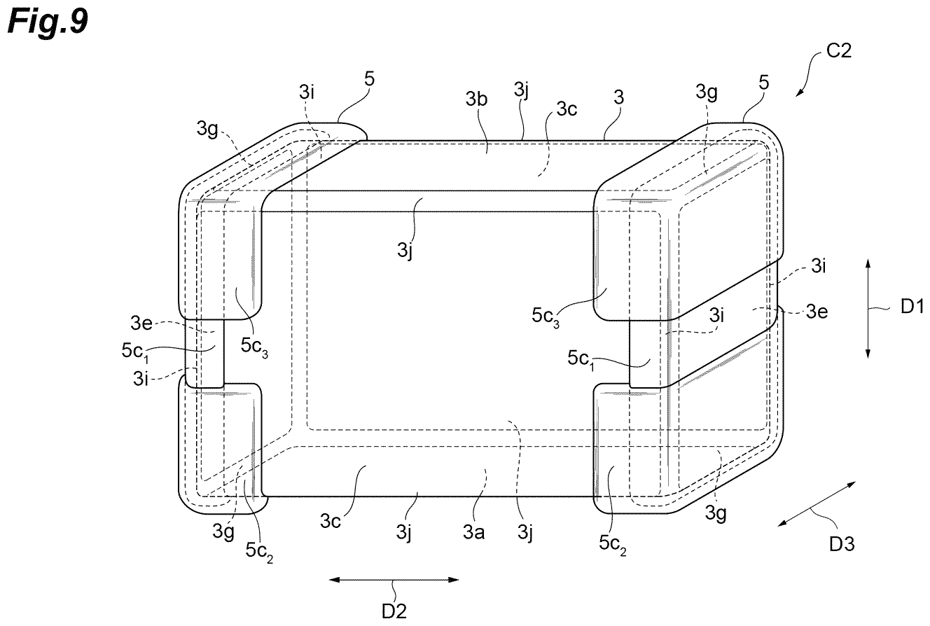

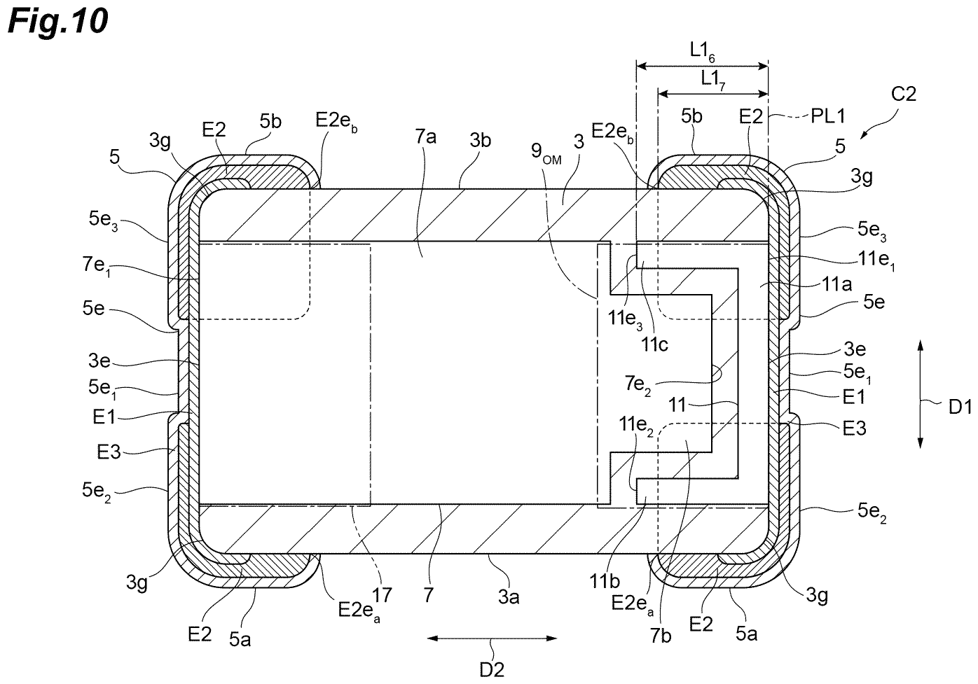

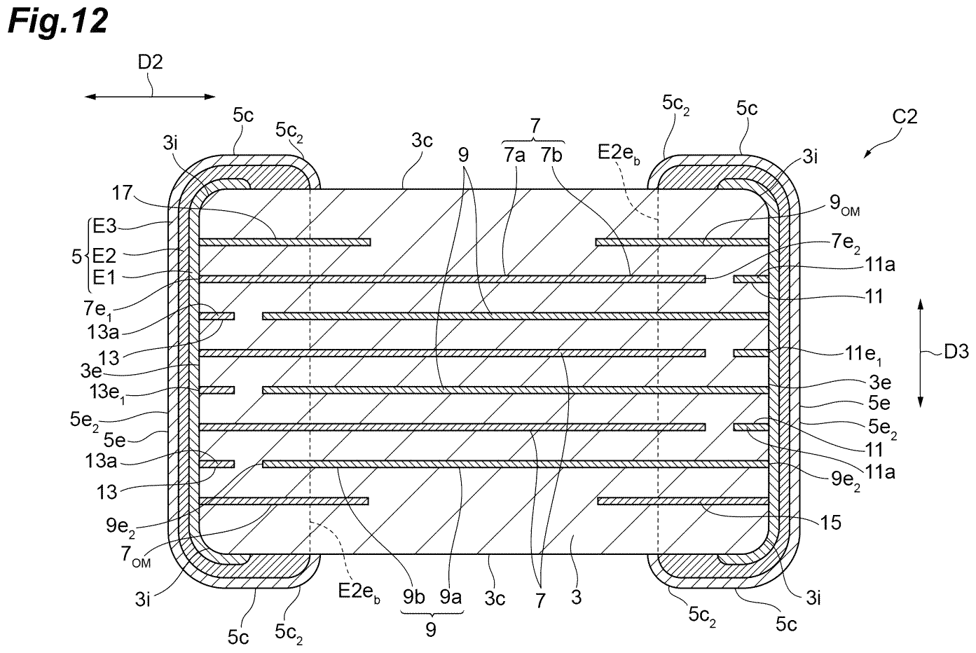

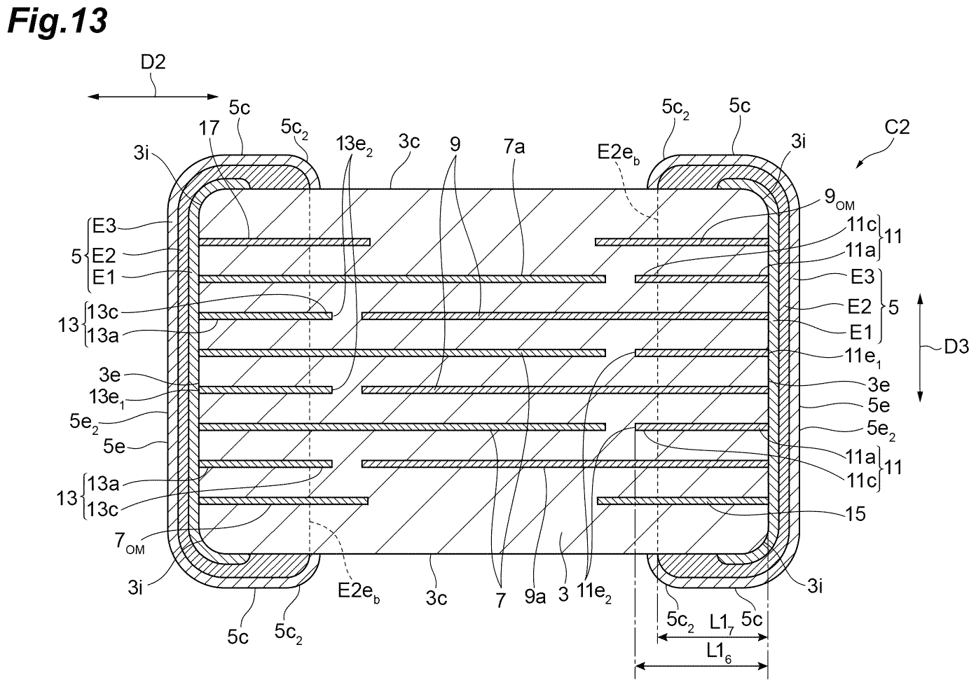

A configuration of a multilayer capacitor C2 according to the second example will be described with reference to FIGS. 9 to 13. FIG. 9 is a perspective view of a multilayer capacitor according to the second example. FIGS. 10, 11, 12, and 13 are views illustrating a cross-sectional configuration of the multilayer capacitor according to the second example. The multilayer capacitor C2 is generally similar to or the same as the above-described modified example of the first example. However, the multilayer capacitor C2 is different from the above-described modified example of the first example in a configuration of the external electrodes 5. Hereinafter, differences between the multilayer capacitor C1 according to the first example and modified example of the first example and the multilayer capacitor C2 will be mainly described.

Also in the second example, an electronic component includes, for example, the multilayer capacitor C2.

In FIG. 10, the lengths L1₁, L1₂, L1₃, L1₄, and L1₅, the distances L₇ₐ₁, L₇ₐ₂, L_{7b1}, L_{7b2}, L₁₁ₐ₁, and L_{11b1}, and the widths W₇ₐ, W_{7b}, W₁₁ₐ, W_{11b}, and W_{11c} illustrated in FIGS. 2 and 7 are omitted. The lengths L1₁, L1₂, L1₃, L1₄, and L1₅, the distances L₇ₐ₁, L₇ₐ₂, L_{7b1}, L_{7b2}, L₁₁ₐ₁, and L_{11b1}, and the widths W₇ₐ, W_{7b}, W₁₁ₐ, W_{11b}, and W_{11c} are defined in the same manner as in the first example and the modified example of the first example.

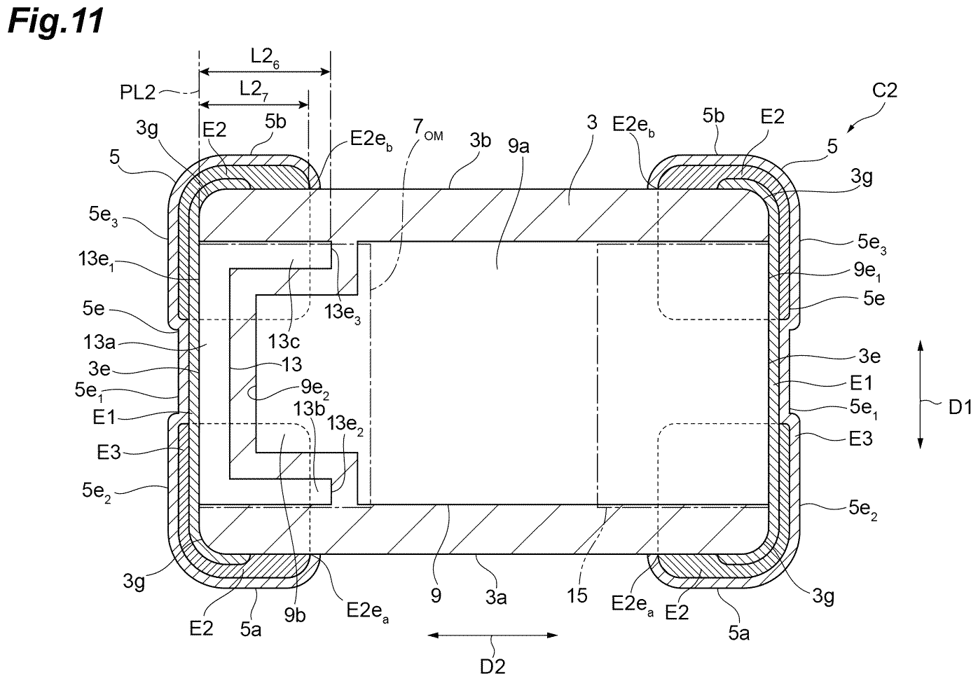

In FIG. 11, the lengths L2₁, L2₂, L2₃, L2₄, and L2₅, the distances L₉ₐ₁, L₉ₐ₂, L_{9b1}, L_{9b2}, L₁₃ₐ₁, and L_{13b1}, and the widths W₉ₐ, W_{9b}, W₁₃ₐ, W_{13b}, and W_{13c} illustrated in FIGS. 3 and 8 are omitted. The lengths L2₁, L2₂, L2₃, L2₄, and L2₅, the distances L₉ₐ₁, L₉ₐ₂, L_{9b1}, L_{9b2}, L₁₃ₐ₁, and L_{13b1}, and the widths W₉ₐ, W_{9b}, W₁₃ₐ, W_{13b}, and W_{13c} are defined in the same manner as in the first example and the modified example of the first example.

As with the multilayer capacitor C1, the multilayer capacitor C2 includes the element body 3 of a rectangular parallelepiped shape, the plurality of external electrodes 5, the plurality of internal electrodes 7, the plurality of internal electrodes 9, the plurality of auxiliary internal electrodes 11, the plurality of auxiliary internal electrodes 13, and the plurality of conductors 15 and 17. In the multilayer capacitor C2, the main surface 3a or the main surface 3b is arranged to constitute a mounting surface.

The external electrode 5 includes the plurality of electrode portions 5a, 5b, 5c, and 5e. Each of the electrode portions 5a, 5c, and 5e includes the first electrode layer E1, the second electrode layer E2, and the third electrode layer E3. In the multilayer capacitor C2, each electrode portion 5b also includes the first electrode layer E1, the second electrode layer E2, and the third electrode layer E3.

The second electrode layer E2 of the electrode portion 5b is disposed on both the first electrode layer E1 and the main surface 3b. The second electrode layer E2 of the electrode portion 5b is formed on the first electrode layer E1 to cover the first electrode layer E1 of the electrode portion 5b, and is formed on the main surface 3b to cover a part of the main surface 3b. The second electrode layer E2 of the electrode portion 5b is in contact with substantially the entire first electrode layer E1 and the above-described part of the main surface 3b. In the electrode portion 5b, the second electrode layer E2 is in direct contact with the first electrode layer E1 and the main surface 3b. In the electrode portion 5b, the second electrode layer E2 indirectly covers the main surface 3b such that the first electrode layer E1 is positioned between the second electrode layer E2 and the main surface 3b. The second electrode layer E2 of the electrode portion 5b is positioned on the main surface 3b. The second electrode layer E2 of the electrode portion 5b includes an end edge E2e_{b} positioned on the main surface 3b.

The third electrode layer E3 of the electrode portion 5b is disposed on the second electrode layer E2. In the electrode portion 5b, the third electrode layer E3 covers the second electrode layer E2. In the electrode portion 5b, the third electrode layer E3 is in contact with the second electrode layer E2. In the electrode portion 5b, the third electrode layer E3 is in direct contact with the second electrode layer E2. In the electrode portion 5b, the third electrode layer E3 is not in direct contact with the first electrode layer E1. The third electrode layer E3 of the electrode portion 5b is positioned on the main surface 3b.

In the electrode portion 5c, the second electrode layer E2 is formed to cover the above-described part of the first electrode layer E1 and the above-described part of the side surface 3c and to cover an other part of the first electrode layer E1 and an other part of the side surface 3c. In the electrode portion 5c, the second electrode layer E2 is in direct contact with the above-described other part of the first electrode layer E1 and the above-described other part of the side surface 3c. The second electrode layer E2 of the electrode portion 5c covers the above-described other part of the first electrode layer E1 of the electrode portion 5c. One region included in the side surface 3c and covered with the second electrode layer E2 is positioned closer to the main surface 3a and the end surface 3e, and an other region included in the side surface 3c and covered with the second electrode layer E2 is positioned closer to the main surface 3b and the end surface 3e, for example. In the electrode portion 5c, the second electrode layer E2 indirectly covers the above-described other part of the side surface 3c such that the first electrode layer E1 is positioned between the second electrode layer E2 and the side surface 3c. The first electrode layer E1 of the electrode portion 5c is covered with the second electrode layer E2 in the above-described part and the above-described other part, and is exposed from the second electrode layer E2 in the remaining part excluding the above-described part and the above-described other part.

As illustrated in FIG. 9, the electrode portion 5c includes a plurality of regions 5c₁, 5c₂, and 5c3. For example, the electrode portion 5c includes only three regions 5c₁, 5c₂, and 5c₃. The region 5c₃ is positioned closer to the main surface 3b than the region 5c₁. The region 5C₃ includes the first electrode layer E1, the second electrode layer E2, and the third electrode layer E3. The region 5c₃ includes a region where the first electrode layer E1 is covered with the second electrode layer E2. In the first direction D1, the region 5c₁ is positioned between the region 5c₂ and the region 5c₃.

In the electrode portion 5e, the second electrode layer E2 is formed to cover the above-described part of the first electrode layer E1, and covers an other part of the first electrode layer E1. In the electrode portion 5e, the second electrode layer E2 is in direct contact with the above-described other part of the first electrode layer E1. The second electrode layer E2 of the electrode portion 5e covers the above-described other part of the first electrode layer E1 of the electrode portion 5c. In the electrode portion 5e, the second electrode layer E2 indirectly covers an other part of the end surface 3e such that the first electrode layer E1 is positioned between the second electrode layer E2 and the end surface 3e. For example, the above-described other part of the end surface 3e is positioned closer to the main surface 3b, in the end surface 3e. The first electrode layer E1 of the electrode portion 5e is covered with the second electrode layer E2 in the above-described part and the above-described other part, and is exposed from the second electrode layer E2 in the remaining part excluding the above-described part and the above-described other part.

The electrode portion 5e includes a plurality of regions 5e₁, 5e₂, and 5e₃. For example, the electrode portion 5e includes only three regions 5e₁, 5e₂, and 5e₃. The region 5e₃ is positioned closer to the main surface 3b than the region 5e₁. The region 5e₃ includes the first electrode layer E1, the second electrode layer E2, and the third electrode layer E3. The region 5e₃ includes a region where the first electrode layer E1 is covered with the second electrode layer E2. In the first direction D1, the region 5e₁ is positioned between the region 5e₂ and the region 5e₃.

In the multilayer capacitor C2, the second electrode layer E2 continuously covers only a part of the main surface 3a, only a part of the end surface 3e, and only a part of each of the pair of side surfaces 3c, and continuously covers only a part of the main surface 3b, only an other part of the end surface 3e, and only an other part of each of the pair of side surfaces 3c. The second electrode layer E2 includes a first portion disposed to continuously cover only a part of the main surface 3a, only a part of the end surface 3e, and only a part of each of the pair of side surfaces 3c, and a second portion disposed to continuously cover only a part of the main surface 3b, only an other part of the end surface 3e, and only an other part of each of the pair of side surfaces 3c. The above-described part of the end surface 3e is positioned closer to the main surface 3a. The above-described part of each side surface 3c is positioned closer to the main surface 3a. The above-described other part of the end surface 3e is positioned closer to the main surface 3b. The above-described other part of each side surface 3c is positioned closer to the main surface 3b. The second electrode layer E2 covers the whole of one ridge portion 3g, only a part of the ridge portion 3i, and only a part of the ridge portion 3j, and covers the whole of an other ridge portion 3g, only an other part of the ridge portion 3i, and only an other part of the ridge portion 3j.

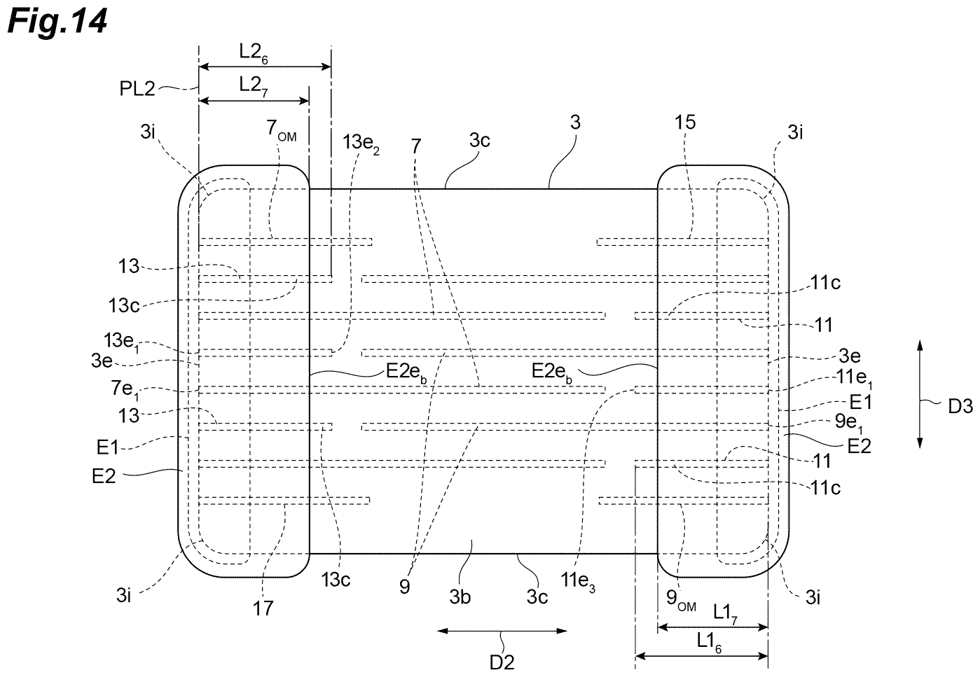

As illustrated in FIG. 10, the auxiliary internal electrode 11 and the second electrode layer 5b of the electrode portion E2 that are electrically connected to each other have a relationship in which the length L1₆ is larger than a length L1₇ from the reference surface PL1 to the edge E2e_{b}. The length L1₆ may be a maximum length of the auxiliary internal electrodes 11 in the second direction D2. As illustrated in FIG. 14, when the auxiliary internal electrode 11 and the second electrode layer E2 of the electrode portion 5b electrically connected to the auxiliary internal electrode 11 are viewed from the first direction D1, the electrode portion 11c includes a portion exposed from the second electrode layer E2 of the electrode portion 5b electrically connected to the auxiliary internal electrode 11. FIG. 14 is a view illustrating a relationship among an internal electrode, an auxiliary internal electrode, and a second electrode layer.

Also in the multilayer capacitor C2, the internal electrode 7 and the auxiliary internal electrode 11 that are disposed in the same layer have a relationship in which a length of the auxiliary internal electrode 11 from the reference plane PL1 is larger than a length from the reference plane PL1 to the internal electrode 7. The length of the auxiliary internal electrode 11 from the reference plane PL1 may be defined by, for example, the length L1₆.

The internal electrode 7 and the second electrode layer E2 of the electrode portion 5b that are not electrically connected to each other have a relationship in which a length of the internal electrode 7 from a reference plane PL2 is larger than a length from the reference plane PL2 to the and edge E2e_{b} of the second electrode layer E2 of the electrode portion 5b that is not electrically connected to the internal electrode 7. The length from the reference plane PL2 to the above-described end edge E2e_{b} is defined by, for example, a length from the reference plane PL2 to the above-described end edge E2e_{b} in the second direction D2.

As illustrated in FIG. 11, the auxiliary internal electrode 13 and the second electrode layer E2 of the electrode portion 5b that are electrically connected to each other have a relationship in which the length L1₆ is larger than a length L1₇ from the reference surface PL2 to the end edge E2e_{b}. The length L1₆ may include a maximum length of the auxiliary internal electrode 13 in the second direction D2. As illustrated in FIG. 14, when the auxiliary internal electrode 13 and the second electrode layer E2 of the electrode portion 5b electrically connected to the auxiliary internal electrode 13 are viewed from the first direction D1, the electrode portion 11c includes a portion exposed from the second electrode layer E2 of the electrode portion 5b electrically connected to the auxiliary internal electrode 13.

Also in the multilayer capacitor C2, the internal electrode 9 and the auxiliary internal electrode 13 that are disposed in the same layer have a relationship in which a length of the auxiliary internal electrode 13 from the reference plane PL2 is larger than a length from the reference plane PL2 to the internal electrode 9. The length of the auxiliary internal electrode 13 from the reference plane PL2 may be defined by, for example, the length L2₆.

The internal electrode 9 and the second electrode layer E2 of the electrode portion 5b that are not electrically connected to each other have a relationship in which a length of the internal electrode 9 from a reference plane PL1 is larger than a length from the reference plane PL1 to the and edge E2e_{b} of the second electrode layer E2 of the electrode portion 5b that is not electrically connected to the internal electrode 9. The length from the reference plane PL1 to the above-described end edge E2e_{b} is defined by, for example, a length from the reference plane PL1 to the above-described end edge E2e_{b} in the second direction D2.

In the multilayer capacitor C2, the electrode portion 11c is positioned between the second electrode layer E2 included in the electrode portion 5b of the external electrode 5 to which the auxiliary internal electrode 11 is electrically connected and the internal electrode 7 in the same layer as the auxiliary internal electrode 11. The electrode portion 11c is positioned between the second electrode layer E2 of the electrode portion 5b and the internal electrode 7 that are not electrically connected to each other. Therefore, electric field tends not to be generated between the second electrode layer E2 of the electrode portion 5b and the internal electrode 7 that are not electrically connected to each other.

In the multilayer capacitor C2, the electrode portion 13c is positioned between the second electrode layer E2 included in the electrode portion 5b of the external electrode 5 to which the auxiliary internal electrode 13 is electrically connected and the internal electrode 9 in the same layer as the auxiliary internal electrode 13. The electrode portion 13c is positioned between the second electrode layer E2 of the electrode portion 5b and the internal electrode 9 that are not electrically connected to each other. Therefore, electric field tends not to be generated between the second electrode layer E2 of the electrode portion 5b and the internal electrode 9 that are not electrically connected to each other.

Consequently, the multilayer capacitor C2 reduces occurrence of migration.

In the multilayer capacitor C2, the electrode portion 11c is positioned between the second electrode layer E2 of the electrode portion 5b to which the internal electrode 7 is not electrically connected and the electrode portion 7b. Therefore, the multilayer capacitor C2 prevents a decrease in an area of the internal electrode 7.

In the multilayer capacitor C2, the electrode portion 13c is positioned between the second electrode layer E2 of the electrode portion 5b to which the internal electrode 9 is not electrically connected and the electrode portion 9b. Therefore, the multilayer capacitor C2 prevents a decrease in an area of the internal electrode 9.

In the multilayer capacitor C2, the auxiliary internal electrode 11 and the second electrode layer E2 of the electrode portion 5b that are electrically connected to each other have a relationship in which the length L1₆ from the reference plane PL1 to the end 11e₃ is larger than the length L1₇ from the reference plane PL1 to the end edge E2e_{b}. Therefore, the electric field tends not to be reliably generated between the second electrode layer E2 of the electrode portion 5b and the internal electrode 7 that are not electrically connected to each other.

In the multilayer capacitor C2, the auxiliary internal electrode 13 and the second electrode layer E2 of the electrode portion 5b that are electrically connected to each other have a relationship in which the length L2₆ from the reference plane PL2 to the end 13e₃ is larger than the length L2₇ from the reference plane PL2 to the end edge E2e_{b}. Therefore, the electric field tends not to be reliably generated between the second electrode layer E2 of the electrode portion 5b and the internal electrode 9 that are not electrically connected to each other.

Consequently, the multilayer capacitor C2 reliably reduces the occurrence of the migration.

In the multilayer capacitor C2, when the auxiliary internal electrode 11 and the second electrode layer E2 of the electrode portion 5b electrically connected to the auxiliary internal electrode 11 are viewed from the first direction D1, the electrode portion 11c includes the portion exposed from the second electrode layer E2 of the electrode portion 5b electrically connected to the auxiliary internal electrode 11. Therefore, the electric field tends not to be reliably generated between the second electrode layer E2 of the electrode portion 5b and the internal electrode 7 that are not electrically connected to each other.

In the multilayer capacitor C2, when the auxiliary internal electrode 13 and the second electrode layer E2 of the electrode portion 5b electrically connected to the auxiliary internal electrode 13 are viewed from the first direction D1, the electrode portion 13c includes the portion exposed from the second electrode layer E2 of the electrode portion 5b electrically connected to the auxiliary internal electrode 13. Therefore, the electric field tends not to be reliably generated between the second electrode layer E2 of the electrode portion 5b and the internal electrode 9 that are not electrically connected to each other.

Consequently, the multilayer capacitor C2 reliably reduces the occurrence of the migration.

Also in the multilayer capacitor C2, the internal electrode 7 and the auxiliary internal electrode 11 that are disposed in the same layer have a relationship in which the length of the auxiliary internal electrode 11 from the reference plane PL1 is larger than the length from the reference plane PL1 to the internal electrode 7.

Also in the multilayer capacitor C2, the internal electrode 9 and the auxiliary internal electrode 13 that are disposed in the same layer have a relationship in which the length of the auxiliary internal electrode 13 from the reference plane PL2 is larger than the length from the reference plane PL2 to the internal electrode 9.

Therefore, the multilayer capacitor C2 reliably reduces the occurrence of the migration.

Also in the multilayer capacitor C2, the internal electrode 7 and the auxiliary internal electrode 11 that are disposed in the same layer have a relationship in which the length from the reference plane PL1 to the internal electrode 7 is smaller than the length of the auxiliary internal electrode 11 from the reference plane PL1. Therefore, the multilayer capacitor C2 can increase capacitance.

Also in the multilayer capacitor C2, the internal electrode 9 and the auxiliary internal electrode 13 that are disposed in the same layer have a relationship in which the length from the reference plane PL2 to the internal electrode 9 is smaller than the length of the auxiliary internal electrode 13 from the reference plane PL2. Therefore, the multilayer capacitor C2 can increase capacitance.

In the multilayer capacitor C2, the internal electrode 7 and the second electrode layer E2 of the electrode portion 5b that are not electrically connected to each other have a relationship in which the length of the internal electrode 7 from the reference plane PL2 is larger than the length from the reference plane PL2 to the end edge E2e_{b} of the second electrode layer E2 of the electrode portion 5b not electrically connected to the internal electrode 7. The multilayer capacitor C2 can increase a length of the internal electrode 7 in the second direction D2. Therefore, the multilayer capacitor C2 can increase capacitance.

In the multilayer capacitor C2, the internal electrode 9 and the second electrode layer E2 of the electrode portion 5b that are not electrically connected to each other have a relationship in which the length of the internal electrode 9 from the reference plane PL1 is larger than the length from the reference plane PL1 to the end edge E2e_{b} of the second electrode layer E2 of the electrode portion 5b not electrically connected to the internal electrode 9. The multilayer capacitor C2 can increase a length of the internal electrode 9 in the second direction D2. Therefore, the multilayer capacitor C2 can increase capacitance.

### Third Example

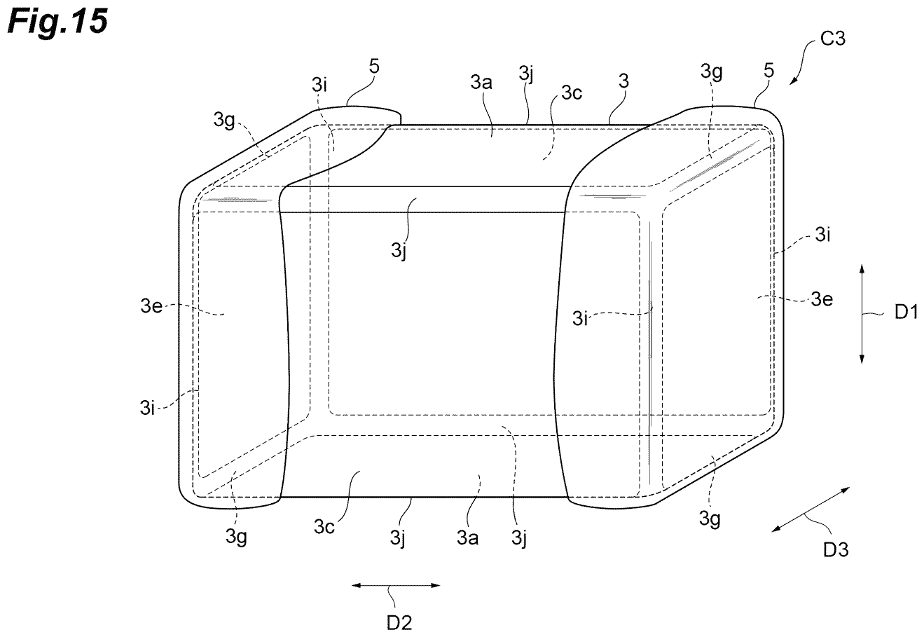

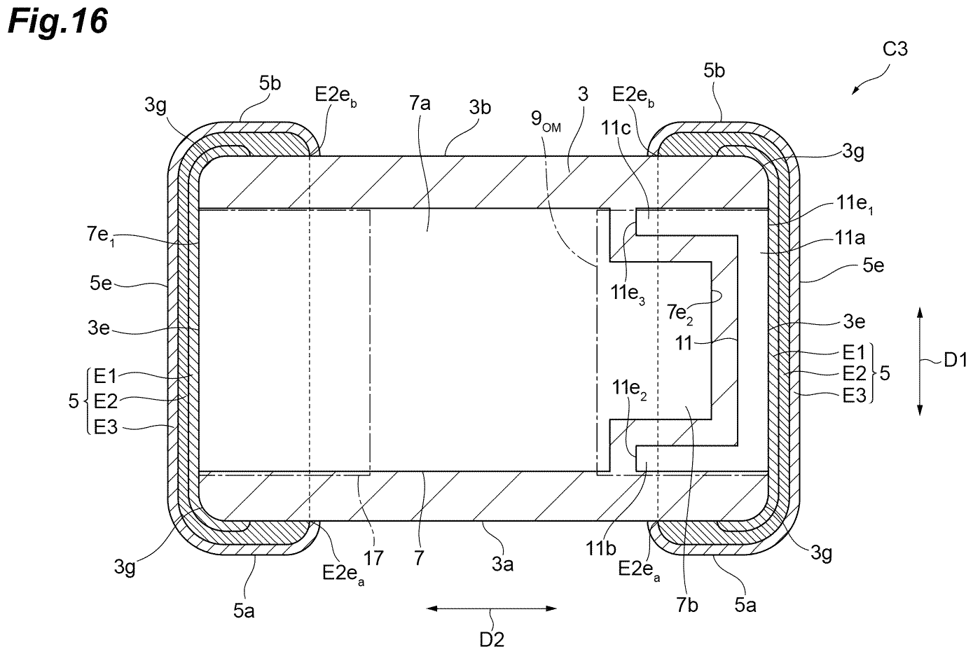

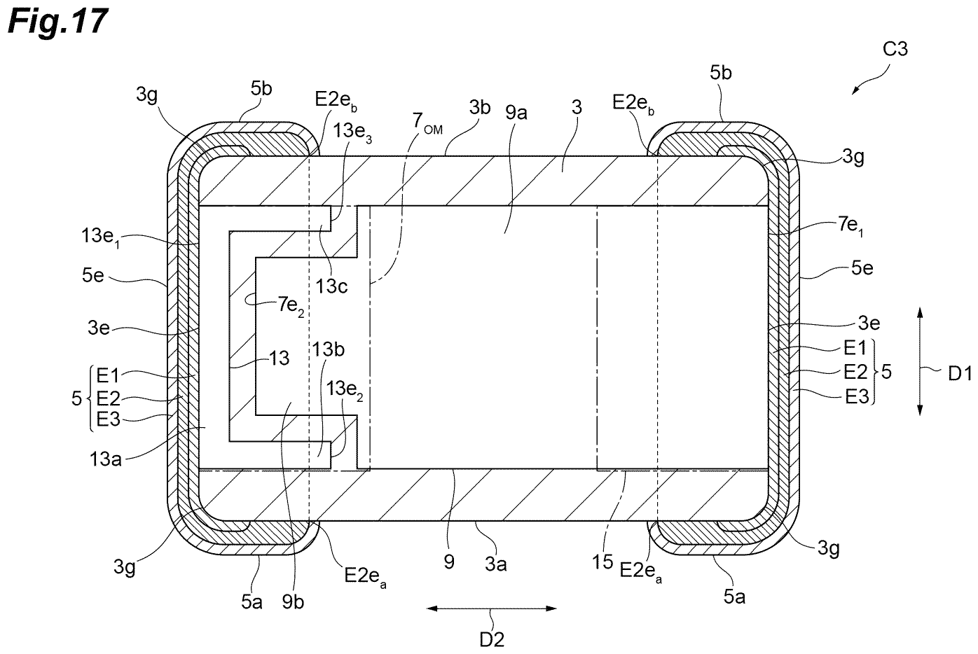

A configuration of a multilayer capacitor C3 according to the third example will be described with reference to FIGS. 15 to 17. FIG. 15 is a perspective view of a multilayer capacitor according to the third example. FIGS. 16 and 17 are views illustrating a cross-sectional configuration of the multilayer capacitor according to the third example. The multilayer capacitor C3 is generally similar to or the same as the above-described multilayer capacitors C1 and C2. However, the multilayer capacitor C3 is different from the above-described multilayer capacitors C1 and C2 in a configuration of the external electrodes 5. Hereinafter, differences between the multilayer capacitors C1 and C2 and the multilayer capacitor C3 will be mainly described.

Also in the third example, an electronic component includes, for example, the multilayer capacitor C3.

In FIG. 16, the lengths L1₁, L1₂, L1₃, L1₄, L1₅, L1₆, and L1₇, the distances L₇ₐ₁, L₇ₐ₂, L_{7b1}, L_{7b2}, L₁₁ₐ₁, and L_{11b1}, and the widths W₇ₐ, W_{7b}, W₁₁ₐ, W_{11b}, and W_{11c} illustrated in FIGS. 2, 7, and 10 are omitted. The lengths L1₁, L1₂, L1₃, L1₄, L1₅, L1₆, and L1₇, the distances L₇ₐ₁, L₇ₐ₂, L_{7b1}, L_{7b2}, L₁₁ₐ₁, and L_{11b1}, and the widths W₇ₐ, W_{7b}, W₁₁ₐ, W_{11b}, and W_{11c} are defined in the same manner as in the first example, the modified example of the first example, and the second example.

In FIG. 17, the lengths L2₁, L2₂, L2₃, L2₄, L2₅, L2₆, and L2₇, the distances L₉ₐ₁, L₉ₐ₂, L_{9b1}, L_{9b2}, L₁₃ₐ₁, and L_{13b1}, and the widths W₉ₐ, W_{9b}, W₁₃ₐ, W_{13b}, and W_{13c} illustrated in FIGS. 3, 8, and 11 are omitted. The lengths L2₁, L2₂, L2₃, L2₄, L2₅, L2₆, and L2₇, the distances L₉ₐ₁, L₉ₐ₂, L_{9b1}, L_{9b2}, L₁₃ₐ₁, and L_{13b1}, and the widths W₉ₐ, W_{9b}, W₁₃ₐ, W_{13b}, and W_{13c} are defined in the same manner as in the first example, the modified example of the first example, and the second example.

As with the multilayer capacitors C1 and C2, the multilayer capacitor C3 includes the element body 3 of a rectangular parallelepiped shape, the plurality of external electrodes 5, the plurality of internal electrodes 7, the plurality of internal electrodes 9, the plurality of auxiliary internal electrodes 11, the plurality of auxiliary internal electrodes 13, and the plurality of conductors 15 and 17. In the multilayer capacitor C2, the main surface 3a or the main surface 3b is arranged to constitute a mounting surface.

The external electrode 5 includes the plurality of electrode portions 5a, 5b, 5c, and 5e. Each of the electrode portions 5a, 5b, 5c, and 5e includes the first electrode layer E1, the second electrode layer E2, and the third electrode layer E3.

The second electrode layer E2 of the electrode portion 5c is disposed both on the first electrode layer E1 and the side surface 3c. In the electrode portion 5c, the second electrode layer E2 is formed on the first electrode layer E1 to cover the first electrode layer E1 of the electrode portion 5c, and is formed on the side surface 3c to cover a part of the side surface 3c. In the electrode portion 5c, the second electrode layer E2 is in contact with the above-described part of the side surface 3c, and is in contact with substantially the entire first electrode layer E1. The first electrode layer E1 of the electrode portion 5c is entirely covered with the second electrode layer E2. The first electrode layer E1 of the electrode portion 5c does not include a region exposed from the second electrode layer E2.

The second electrode layer E2 of the electrode portion 5e is disposed on the first electrode layer E1. In the electrode portion 5e, the second electrode layer E2 is formed on the first electrode layer E1 to cover the first electrode layer E1 of the electrode portion 5e. In the electrode portion 5e, the second electrode layer E2 is in contact with substantially the entire first electrode layer E1. The first electrode layer 5e of the electrode portion E1 is entirely covered with the second electrode layer E2. The first electrode layer E1 of the electrode portion 5e does not include a region exposed from the second electrode layer E2.

Also in the multilayer capacitor C3, the electrode portion 11b is positioned between the second electrode layer E2 of the electrode portions 5a and the internal electrode 7 that are not electrically connected to each other. The electrode portion 11c is positioned between the second electrode layer E2 of the electrode portions 5b and the internal electrode 7 that are not electrically connected to each other. The electrode portion 13b is positioned between the second electrode layer E2 of the electrode portions 5a and the internal electrode 9 that are not electrically connected to each other. The electrode portion 11c is positioned between the second electrode layer E2 of the electrode portions 5b and the internal electrode 9 that are not electrically connected to each other.

Therefore, as with the multilayer capacitors C1 and C2, the multilayer capacitor C3 reduces occurrence of migration.

### Fourth Example

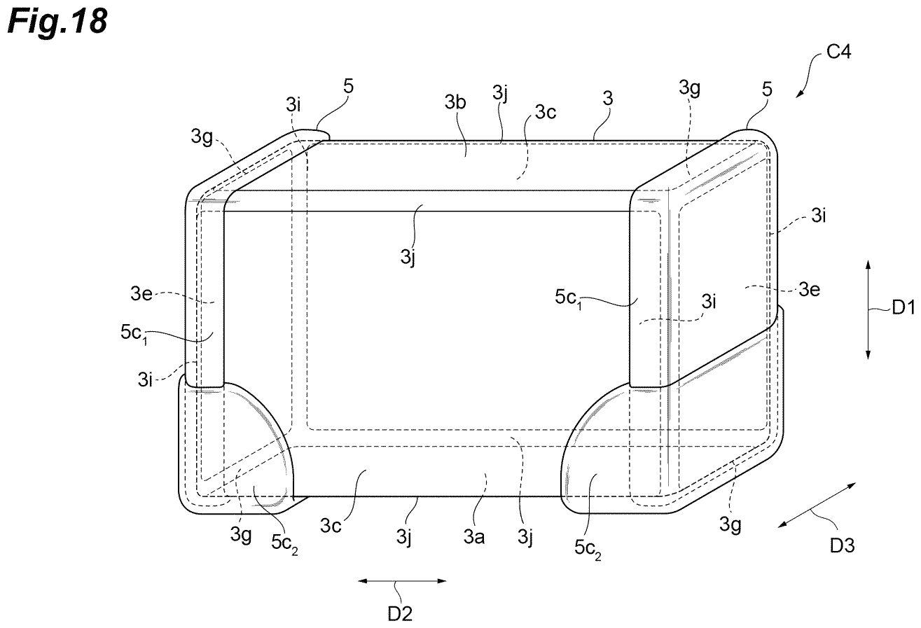

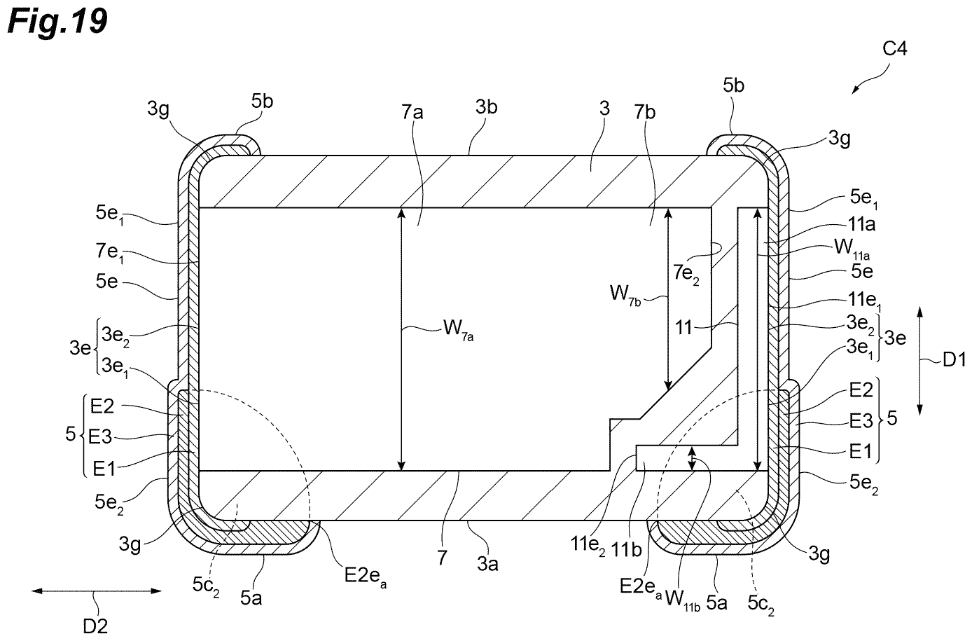

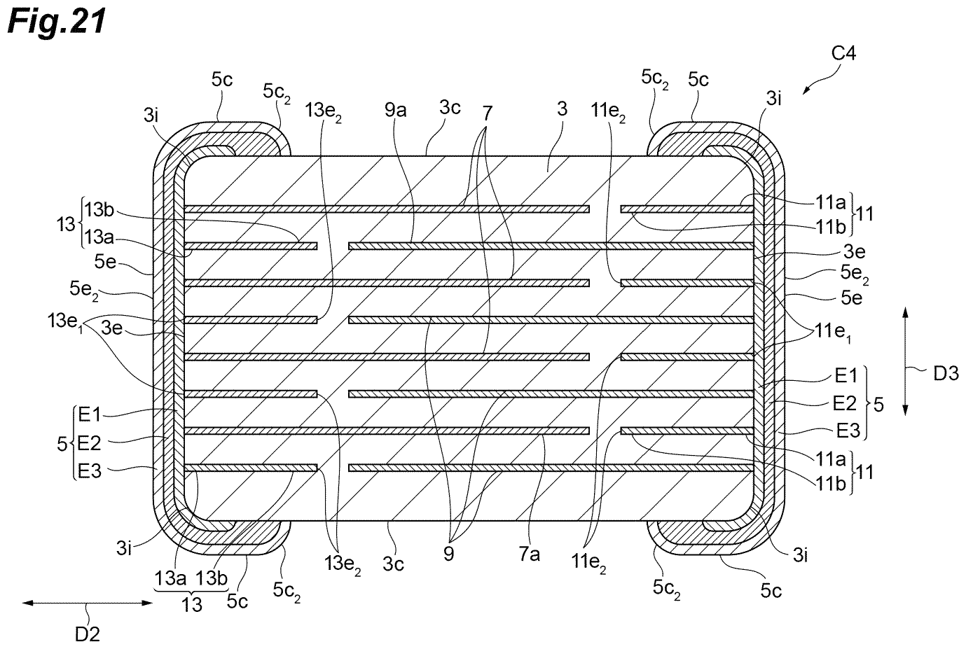

A configuration of a multilayer capacitor Ca according to the fourth example will be described with reference to FIGS. 18 to 21. FIG. 18 is a perspective view of a multilayer capacitor according to the fourth example. FIGS. 19, 20, and 21 are views illustrating a cross-sectional configuration of the multilayer capacitor according to the fourth example. The multilayer capacitor C4 is generally similar to or the same as the above-described multilayer capacitor C1. However, the multilayer capacitor C4 is different from the above-described multilayer capacitor C1 in a configuration of the external electrodes 5 and the internal electrodes 7 and 9. Hereinafter, differences between the multilayer capacitor C1 and the multilayer capacitor C4 will be mainly described.

Also in the third example, an electronic component includes, for example, the multilayer capacitor C4.

In FIG. 19, the lengths L1₁, L1₂, L1₃, L1₄, and L1₅ and the distances L₇ₐ₁, L₇ₐ₂, L_{7b1}, L_{7b2}, and L₁₁ₐ₁ illustrated in FIG. 2 are omitted. The lengths L1₁, L1₂, L1₃, L1₄, and L1₅ and the distances L₇ₐ₁, L₇ₐ₂, L_{7b1}, L_{7b2}, and L₁₁ₐ₁ are defined in the same manner as in the above-described first example.

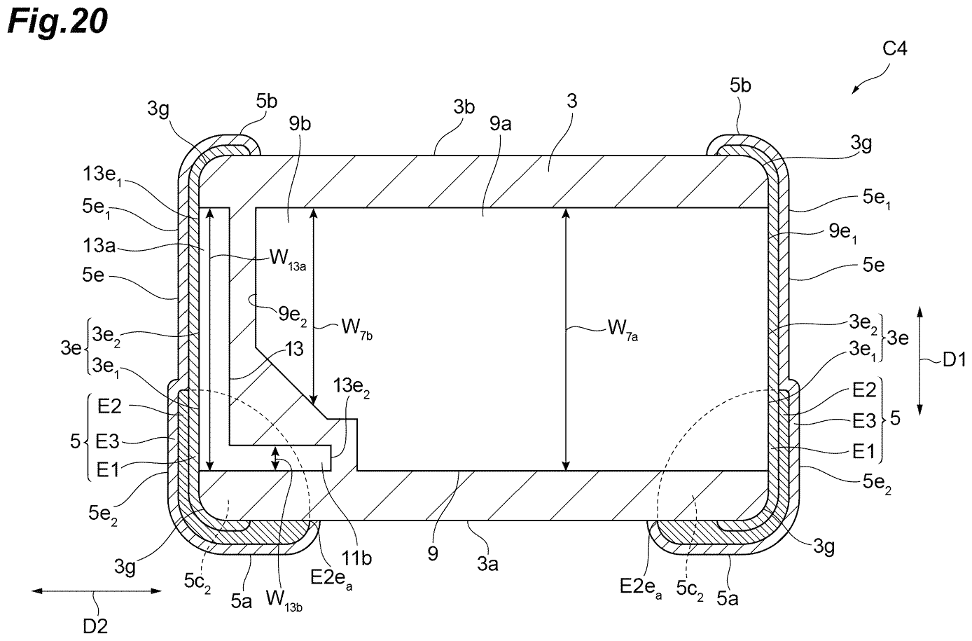

In FIG. 20, the lengths L2₁, L2₂, L2₃, L2₄, and L2₅ and the distances L₉ₐ₁, L₉ₐ₂, L_{9b1}, L_{9b2}, and L₁₃ₐ₁ illustrated in FIG. 3 are omitted. The lengths L2₁, L2₂, L2₃, L2₄, and L2₅ and the distances L₉ₐ₁, L₉ₐ₂, L_{9b1}, L_{9b2}, and L₁₃ₐ₁ are defined in the same manner as in the above-described first example.

The multilayer capacitor C4 includes the element body 3 of a rectangular parallelepiped shape, the plurality of external electrodes 5, the plurality of internal electrodes 7, the plurality of internal electrodes 9, the plurality of auxiliary internal electrodes 11, and the plurality of auxiliary internal electrodes 13. The multilayer capacitor C4 does not include the plurality of conductors 15 and 17.

A width of the region 502 in the second direction D2 decreases with an increase in distance from the main surface 3a (electrode portion 5a). A width of the region 5c₂ in the first direction D1 decreases with an increase in distance from the end surface 3e (electrode portion 5e). For example, an end edge of the region 502 has an approximately arc shape when viewed from the third direction D3. The region 5c₂ has an approximately fan shape when viewed from the third direction D3.

As illustrated in FIGS. 19 and 20, a width of the second electrode layer E2 in the second direction D2 decreases with an increase in distance from the main surface 3a. A width of the second electrode layer E2 in the first direction D1 decreases with an increase in distance from the end surface 3e. For example, the second electrode layer E2 included in the region 5c₂ has an approximately fan shape when viewed from the third direction D3. The region 5c₂ is positioned on the side surface 3c. The second electrode layer E2 included in the region 502 may have a substantially rectangular shape when viewed from the third direction D3.

The internal electrode 7 does not overlap the second electrode layer E2 that is included in the region 5c₂ and is not electrically connected to the internal electrode 7 when viewed from the third direction D3. The electrode portion 7a does not overlap the second electrode layer E2 that is included in the region 502 and is not electrically connected to the internal electrode 7 when viewed from the third direction D3. The width W_{7b} decreases with a decrease in distance to the end surface 3e to which the auxiliary internal electrode 11 is exposed.

The internal electrode 9 does not overlap the second electrode layer E2 that is included in the region 5c₂ and is not electrically connected to the internal electrode 9 when viewed from the third direction D3. The electrode portion 9a does not overlap the second electrode layer E2 that is included in the region 502 and is not electrically connected to the internal electrode 9 when viewed from the third direction D3. The width W_{9b} decreases with a decrease in distance to the end surface 3e to which the auxiliary internal electrode 13 is exposed.

Also in the multilayer capacitor C4, the electrode portion 11b is positioned between the second electrode layer E2 of the electrode portions 5a and the internal electrode 7 that are not electrically connected to each other. The electrode portion 13b is positioned between the second electrode layer E2 of the electrode portions 5a and the internal electrode 9 that are not electrically connected to each other.

Therefore, as with the multilayer capacitor C1, the multilayer capacitor C4 reduces occurrence of migration.

In the multilayer capacitor C4, the internal electrode 7 and the second electrode layer E2 included in the region 5c₂ that are not electrically connected to each other do not overlap each other when viewed from the third direction D3. Therefore, electric field tends not to be generated between the internal electrode 7 and the second electrode layer E2 included in the region 5c₂ that are not electrically connected to each other.

In the multilayer capacitor C4, the internal electrode 9 and the second electrode layer E2 included in the region 5c₂ that are not electrically connected to each other do not overlap each other when viewed from the third direction D3. Therefore, electric field tends not to be generated between the internal electrode 9 and the second electrode layer E2 included in the region 5c₂ that are not electrically connected to each other.

Consequently, the multilayer capacitor C4 reduces the occurrence of migration even in a configuration in which the external electrode 5 includes the second electrode layer E2 in the electrode portion 5c.

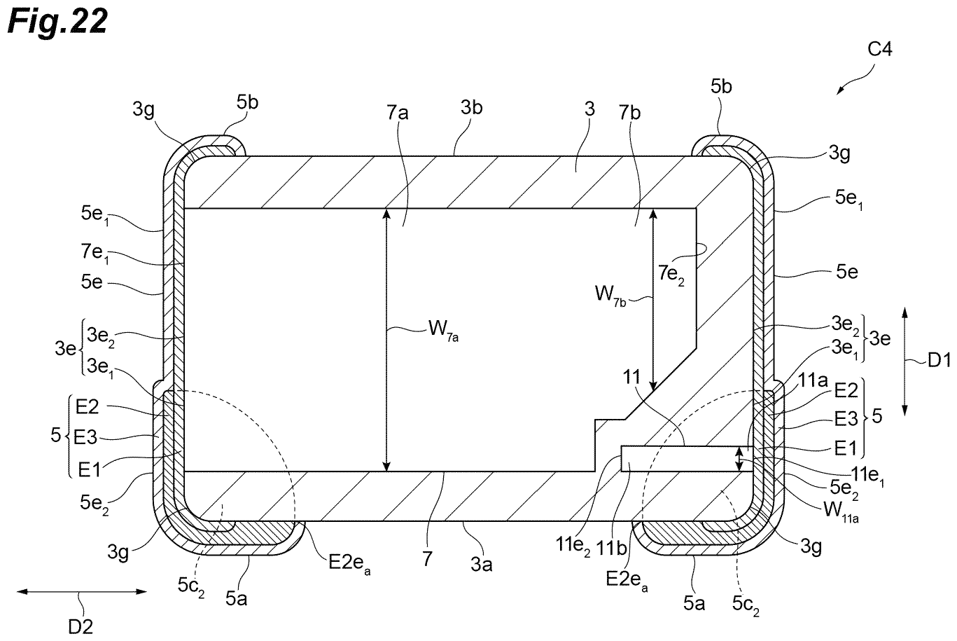

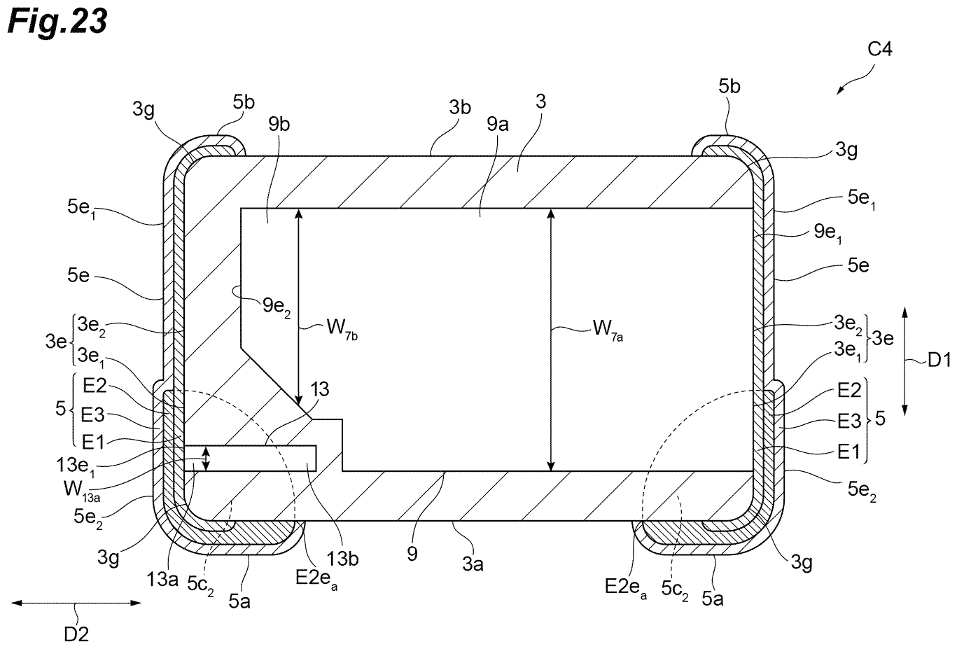

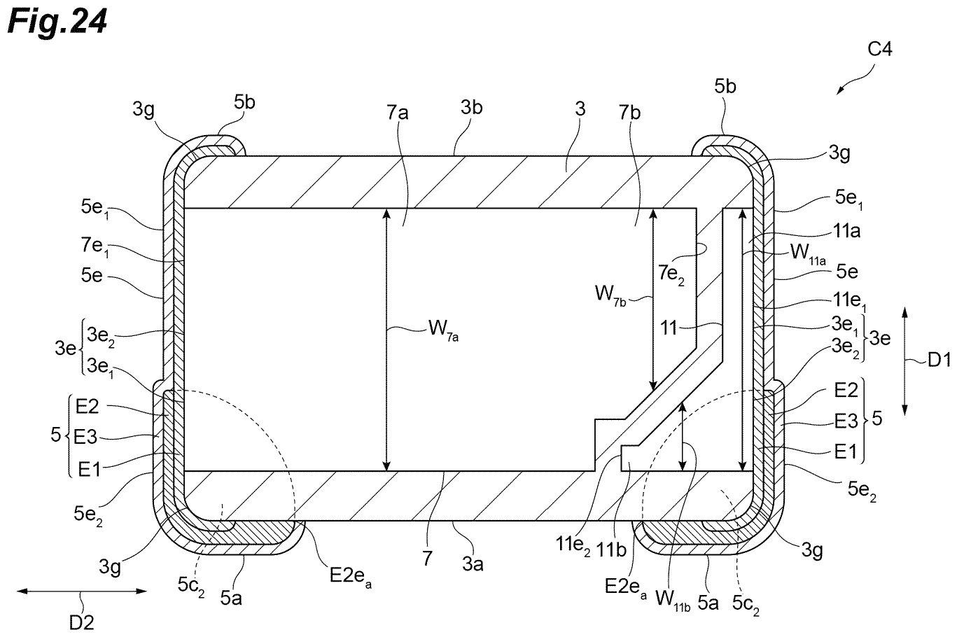

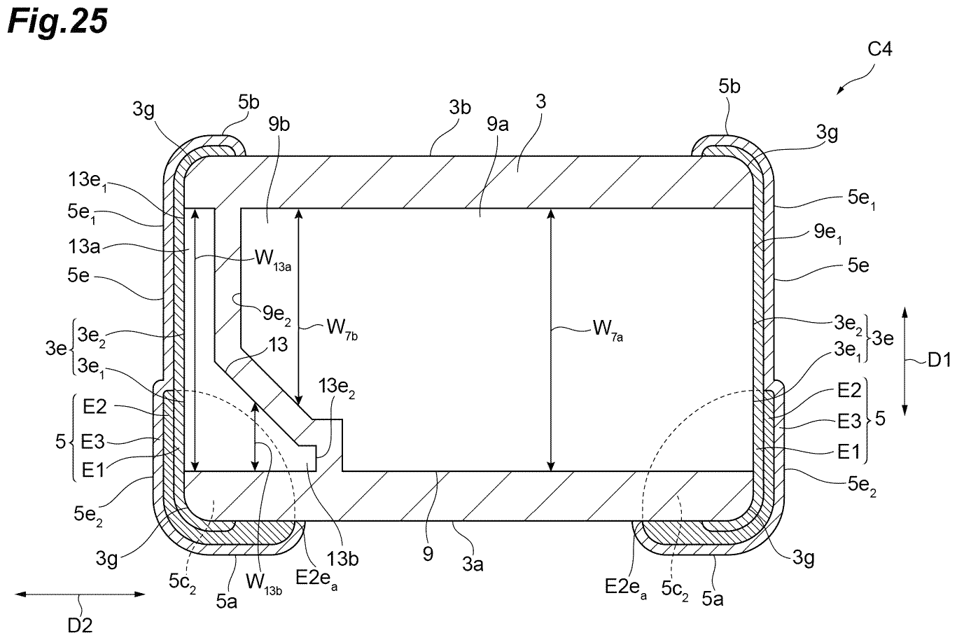

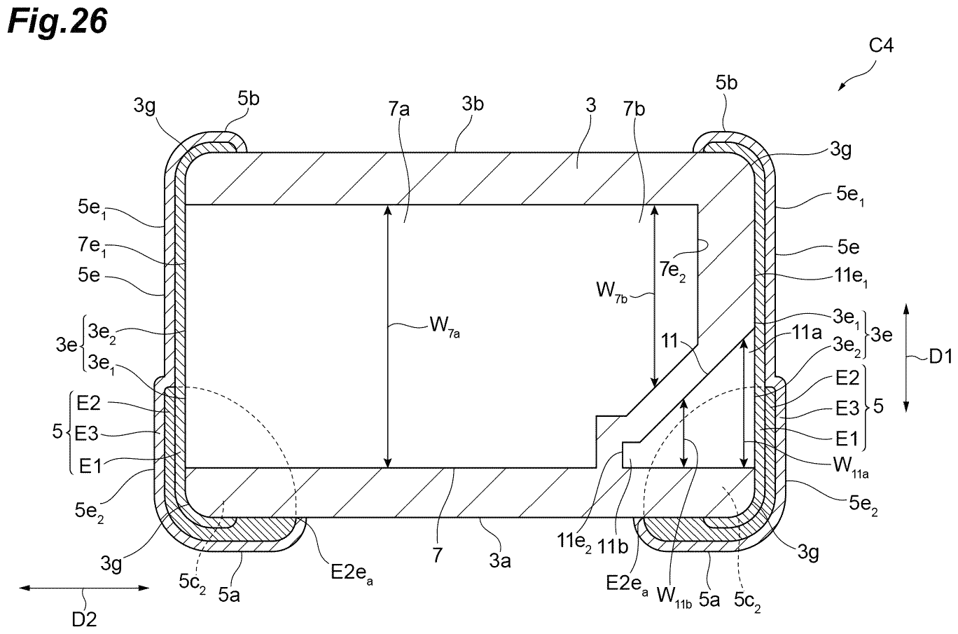

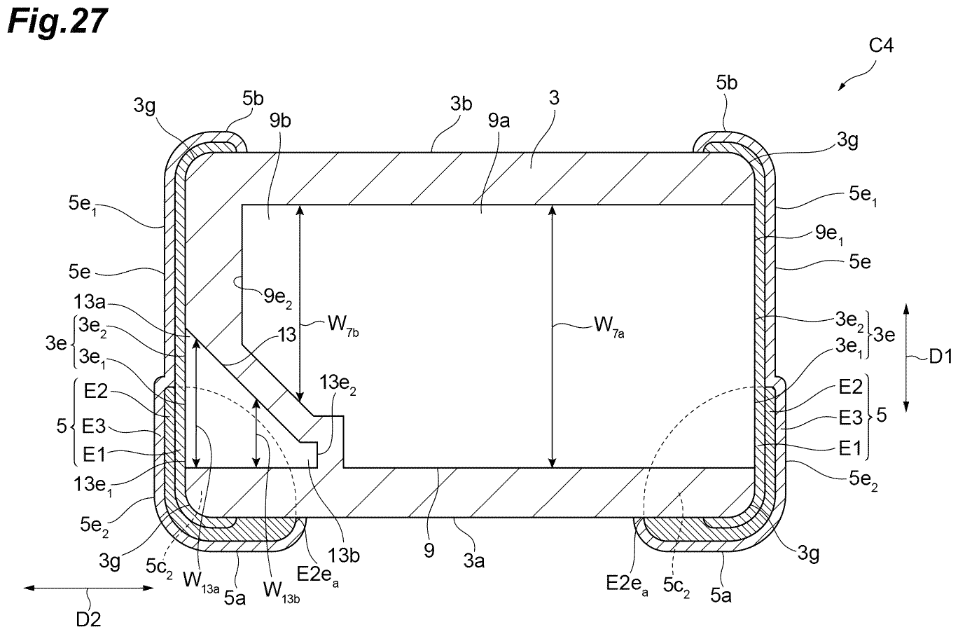

Next, a configuration of multilayer capacitors according to a plurality of modified examples of the fourth example will be described with reference to FIGS. 22 to 27. FIGS. 22 and 23 are views illustrating a cross-sectional configuration of a multilayer capacitor according to one modified example of the fourth example. FIGS. 24 and 25 are views illustrating a cross-sectional configuration of a multilayer capacitor according to another modified example of the fourth example. FIGS. 26 and 27 are views illustrating a cross-sectional configuration of a multilayer capacitor according to still another modified example of the fourth example. The multilayer capacitor according to each modified example of the fourth example is generally similar to or the same as the multilayer capacitor C4. However, the multilayer capacitor according to each modified example of the fourth example is different from the multilayer capacitor C4 in a configuration of the auxiliary internal electrodes 11 and 13. Hereinafter, differences between the multilayer capacitor according to each modified example of the fourth example and the multilayer capacitor C4 will be mainly described.

In one modified example of the fourth example, as illustrated in FIG. 22, the auxiliary internal electrode 11 has a substantially rectangular shape. The width W₁₁ₐ is substantially equal to the width W_{11b}. The electrode portion 11a is exposed to the end surface 3e with the width W₁₁ₐ substantially equal to the width W_{11b} of the electrode portion 11b. As illustrated in FIG. 23, the auxiliary internal electrode 13 has a substantially rectangular shape. The width W₁₃ₐ is substantially equal to the width W_{13b}. The electrode portion 13a is exposed to the end surface 3e with the width W₁₃ₐ substantially equal to the width W_{13b} of the electrode portion 13b. Also in this modified example, the width W₁₁ₐ may be substantially equal to the width W_{11b}, and the width W₁₃ₐ may be substantially equal to the width W_{13b}.

In another modified example of the fourth example, as illustrated in FIG. 24, the width W_{11b} decreases with a decrease in distance to the electrode portion 11a. As illustrated in FIG. 25, the width W_{13b} decreases with a decrease in distance to the electrode portion 13a. Also in this modified example, the width W₁₁ₐ may be substantially equal to the width W_{11b}, and the width W₁₃ₐ may be substantially equal to the width W_{13b}.

In still another modified example of the fourth example, as illustrated in FIG. 26, the width W_{11b} decreases with a decrease in distance to the electrode portion 11a, and the width W₁₁ₐ decreases with a decrease in distance to the end surface 3e to which the electrode portion 11a is exposed. As illustrated in FIG. 27, the width W_{13b} decreases with a decrease in distance to the electrode portion 13a, and the width W₁₃ₐ decreases with a decrease in distance to the end surface 3e to which the electrode portion 13a is exposed.

### Fifth Example

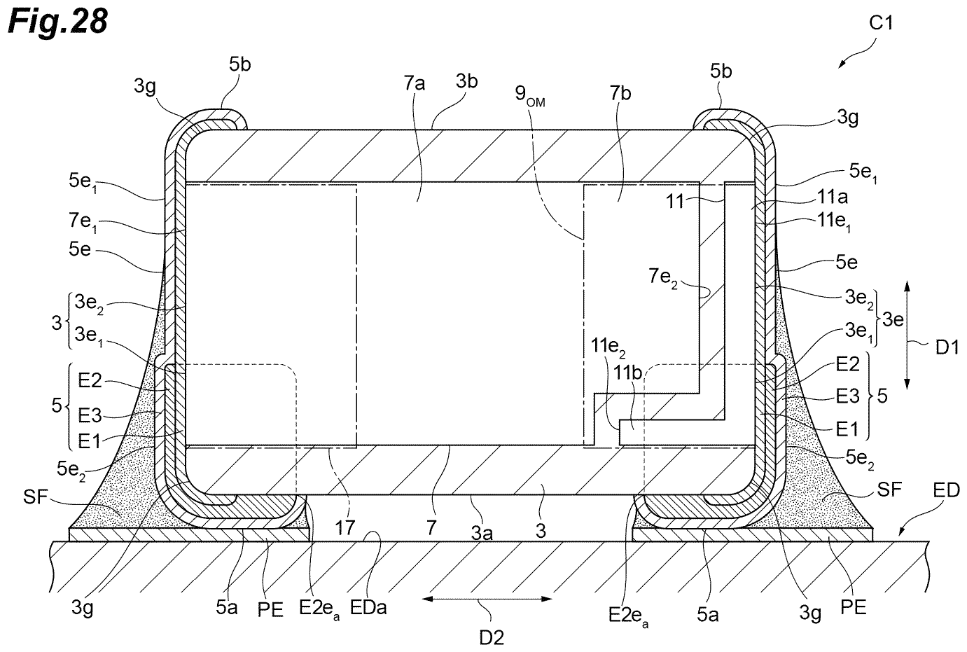

An electronic component device according to the fifth example will be described with reference to FIG. 28. FIG. 28 is a view illustrating a cross-sectional configuration of an electronic component device according to a fifth example.

The electronic component device includes the multilayer capacitor C1 and an electronic device ED. The electronic device ED includes, for example, a circuit board or an electronic component. The multilayer capacitor C1 is solder-mounted on the electronic device ED. The electronic device ED includes a main surface EDa and two pad electrodes PE. Each pad electrode PE is disposed on the main surface EDa. The two pad electrodes PE are separated from each other. The multilayer capacitor C1 is disposed on the electronic device ED in such a manner that the main surface 3a and the main surface EDa oppose each other.

In solder-mounting the multilayer capacitor C1, the molten solder wets the external electrode 5 (third electrode layer E3). Solidification of the wet solder causes a solder fillet SF to be formed on the external electrode 5. The external electrodes 5 and the pad electrodes PE that correspond to each other are connected to each other through the solder fillet SF.

The electronic component device may include the multilayer capacitor C2, the multilayer capacitor C3, or the multilayer capacitor C4 instead of the multilayer capacitor C1.

In the present specification, in a case where an element is described as being disposed on another element, the element may be directly disposed on the other element or be indirectly disposed on the other element. In a case where an element is indirectly disposed on another element, an intervening element is present between the element and the other element. In a case where an element is directly disposed on another element, no intervening element is present between the element and the other element.

In the present specification, in a case where an element is described as being positioned on another element, the element may be directly positioned on the other element or be indirectly positioned on the other element. In a case where an element is indirectly positioned on another element, an intervening element is present between the element and the other element. In a case where an element is directly positioned on another element, no intervening element is present between the element and the other element.

In the present specification, in a case where an element is described as covering another element, the element may directly cover the other element or indirectly cover the other element. In a case where an element indirectly covers another element, an intervening element is present between the element and the other element. In a case where an element directly covers another element, no intervening element is present between the element and the other element.

It is to be understood that not all aspects, advantages and features described herein may necessarily be achieved by, or included in, any one particular example. Indeed, having described and illustrated various examples herein, it should be apparent that other examples may be modified in arrangement and detail.

In the modified example of the first example as well as the second and third examples, the auxiliary internal electrode 11 may include a plurality of electrode portions 11a separated from each other in the first direction D1. That is, the auxiliary internal electrode 11 may include an electrode portion 11a continuous with the electrode portion 11b and an electrode portion 11a continuous with the electrode portion 11c.

In the present examples and modified examples, the electronic component includes the multilayer capacitor. However, applicable electronic component is not limited to the multilayer capacitor. The applicable electronic component includes, for example, a multilayer electronic component such as a multilayer inductor, a multilayer varistor, a multilayer piezoelectric actuator, a multilayer thermistor, a multilayer solid-state battery component, or a multilayer composite component, or electronic components other than the multilayer electronic components.

1. An electronic component, comprising:
an element body of a rectangular parallelepiped shape including a first main surface arranged to constitute a mounting surface, a second main surface opposing the first main surface in a first direction, a pair of end surfaces opposing each other in a second direction, and a pair of side surfaces opposing each other in a third direction;
a plurality of external electrodes disposed on both ends of the element body in the second direction;
a plurality of internal electrodes disposed in the element body to be distributed in the third direction and each electrically connected to a corresponding external electrode of the plurality of external electrodes; and
a plurality of auxiliary internal electrodes each disposed in the same layer as a corresponding internal electrode of the plurality of internal electrodes and each electrically connected to the external electrode to which the corresponding internal electrode is not electrically connected,
wherein each of the plurality of external electrodes includes a conductive resin layer positioned on the first main surface, and
each of the plurality of auxiliary internal electrodes includes:
a first electrode portion exposed to a corresponding end surface of the pair of end surfaces and electrically and physically connected to the external electrode to which the corresponding internal electrode is not electrically connected; and
a second electrode portion positioned between the conductive resin layer included in the external electrode to which the corresponding internal electrode is not electrically connected and the corresponding internal electrode.

2. The electronic component according to claim 1, wherein
the first electrode portion is exposed to the corresponding end surface with a width larger than a width of the second electrode portion.

3. The electronic component according to claim 1, wherein
each of the plurality of internal electrodes includes:
a third electrode portion including a first end exposed to a corresponding end surface of the pair of end surfaces, the third electrode portion having a first width and being separated from the first main surface by a first distance; and
a fourth electrode portion including a second end positioned in the element body and opposing the first end in the second direction, the fourth electrode portion having a second width smaller than the first width and being separated from the first main surface by a second distance larger than the first distance, and
the second electrode portion is positioned between the conductive resin layer included in the external electrode to which the corresponding internal electrode is not electrically connected and the fourth electrode portion.

4. The electronic component according to claim 3, wherein
each of the plurality of external electrodes further includes a conductive resin layer positioned on the second main surface,
the third electrode portion is separated from the second main surface by a third distance,
the fourth electrode portion is separated from the second main surface by a fourth distance larger than the third distance, and
each of the plurality of auxiliary internal electrodes further includes an electrode portion positioned between the conductive resin layer on the second main surface included in the external electrode to which the corresponding internal electrode is not electrically connected and the fourth electrode portion.

5. The electronic component according to claim 1, wherein
the conductive resin layer includes an end edge positioned on the first main surface,
the second electrode portion includes an end opposing an end included in the first electrode portion and exposed to the corresponding end surface in the second direction, and
with a plane including the corresponding end surface as a reference plane, the auxiliary internal electrode and the conductive resin layer that are electrically connected to each other have a relationship in which a length from the reference plane to the end included in the second electrode portion is larger than a length from the reference plane to the end edge included in the conductive resin layer.

6. The electronic component according to claim 1, wherein
when the auxiliary internal electrode and the conductive resin layer that are electrically connected to each other are viewed from a direction orthogonal to the first main surface, the second electrode portion includes a portion exposed from the conductive resin layer.

7. The electronic component according to claim 1, wherein
with a plane including the corresponding end surface to which the auxiliary internal electrode is exposed as a reference plane, the internal electrode and the auxiliary internal electrode that are disposed in the same layer have a relationship in which a length of the auxiliary internal electrode from the reference plane is larger than a length from the reference plane to the internal electrode.

8. The electronic component according to claim 1, wherein
the conductive resin layer includes an end edge positioned on the first main surface, and
with a plane including the end surface to which the internal electrode is exposed as a reference plane, the internal electrode and the conductive resin layer that are not electrically connected to each other have a relationship in which a length of the internal electrode from the reference plane is larger than a length from the reference plane to the end edge included in the conductive resin layer.

9. The electronic component according to claim 1, wherein
each of the plurality of external electrodes further includes a conductive resin layer positioned on the side surface,
the plurality of internal electrodes includes an outermost internal electrode adjacent to the conductive resin layer on the side surface in the third direction and electrically connected to the conductive resin layer on the side surface, and
the conductive resin layer on the side surface not electrically connected to the outermost internal electrode and the outermost internal electrode do not overlap each other when viewed from a direction orthogonal to the side surface.

10. The electronic component according to claim 1, wherein
each of the plurality of external electrodes further includes a conductive resin layer positioned on the side surface, and
the conductive resin layer on the side surface and the internal electrode that are not electrically connected to each other do not overlap each other when viewed from a direction orthogonal to the side surface.

11. The electronic component according to claim 1, wherein
each of the plurality of external electrodes further includes a conductive resin layer positioned on the end surface, and
when the conductive resin layer on the end surface and the end surface are viewed from a direction orthogonal to the end surface, the end surface includes:
a first region covered with the conductive resin layer on the end surface; and
a second region exposed from the conductive resin layer on the end surface and closer to the second main surface than the first region.

12. The electronic component according to claim 1, wherein
the conductive resin layer includes a plurality of silver particles.

13. The electronic component according to claim 1, wherein
each of the plurality of external electrodes includes a sintered metal layer at least partially covered with the conductive resin layer, and
the conductive resin layer positioned on the first main surface includes a portion not covering the sintered metal layer.

14. The electronic component according to claim 4, wherein
each of the plurality of external electrodes includes a sintered metal layer at least partially covered with the conductive resin layer, and
the conductive resin layer positioned on the second main surface includes a portion not covering the sintered metal layer.

15. The electronic component according to claim 9, wherein
each of the plurality of external electrodes includes a sintered metal layer at least partially covered with the conductive resin layer, and
the conductive resin layer positioned on the side surface includes a portion not covering the sintered metal layer.

16. The electronic component according to claim 10, wherein
each of the plurality of external electrodes includes a sintered metal layer at least partially covered with the conductive resin layer, and
the conductive resin layer positioned on the side surface includes a portion not covering the sintered metal layer.

17. The electronic component according to claim 11, wherein
each of the plurality of external electrodes includes a sintered metal layer at least partially covered with the conductive resin layer, and
the sintered metal layer includes a portion covered with the conductive resin layer and a portion exposed from the conductive resin layer, on the end surface.

18. The electronic component according to claim 1, wherein
each of the plurality of external electrodes includes a plating layer including an outermost layer of the external electrode.
